(19) United States
(12) Patent Application Publication
(10) Pub. No.: US 2018/0223187 A1
(43) Pub. Date: Aug. 9, 2018

(54) LIQUID CRYSTAL MEDIUM

(71) Applicant: MERCK PATENT GMBH, Darmstadt (DE)

(72) Inventors: Harald HIRSCHMANN, Darmstadt (DE); Andreas POHLE, Pfungstadt (DE); Sabine SCHOEN, Herten (DE)

(73) Assignee: MERCK PATENT GMBH, DARMSTADT (DE)

(21) Appl. No.: 15/750,407

(22) PCT Filed: Jul. 22, 2016
(86) PCT No.: PCT/EP2016/001278

§ 371 Date: Feb. 5, 2018

(30) Foreign Application Priority Data
Aug. 5, 2015 (DE) 10 2015 010 116.1

(51) Int. Cl. C09K 19/12; C09K 19/34; C09K 19/30; C09K 19/20

(52) U.S. Cl. CPC C09K 19/12; C09K 19/3402; C09K 19/3003; C09K 19/20; C09K 2019/3422; C09K 2019/3016; C09K 2019/3019; C09K 2019/3004; C09K 2019/3009; C09K 2019/3021; C09K 2019/3025; C09K 2019/122; C09K 2019/301; C09K 2019/123

(57) ABSTRACT

The present invention relates to a liquid-crystalline medium (LC medium) which is distinguished by the fact that it comprises one or more compounds of the formula 1

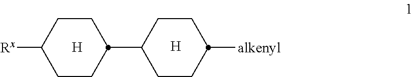

and one or more compounds of the formula 2

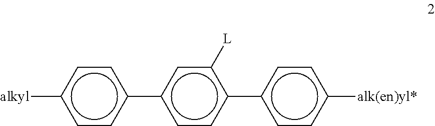

and one or more compounds selected from formulae 3, 4 and 5,

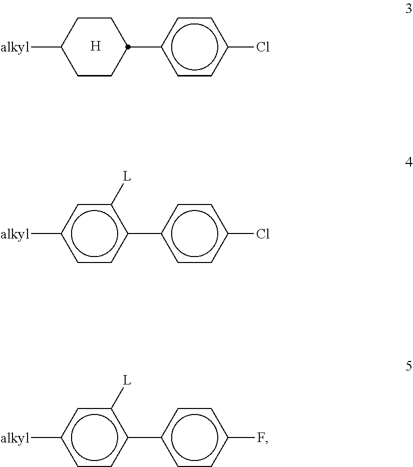

in which the individual radicals have the meanings according to Claim 1, and to the use thereof for electro-optical purposes and to LC displays containing this medium.

The present invention relates to a liquid-crystalline medium (LC medium), to the use thereof for electro-optical purposes, and to LC displays containing this medium.

Liquid crystals are used principally as dielectrics in display devices, since the optical properties of such substances can be modified by an applied voltage. Electro-optical devices based on liquid crystals are extremely well known to the person skilled in the art and can be based on various effects. Examples of such devices are cells having dynamic scattering, DAP (deformation of aligned phases) cells, guest/host cells, TN cells having a twisted nematic structure, STN (supertwisted nematic) cells, SBE (superbirefringence effect) cells and OMI (optical mode interference) cells. The commonest display devices are based on the Schadt-Helfrich effect and have a twisted nematic structure.

The liquid-crystal materials must have good chemical and thermal stability and good stability to electric fields and electromagnetic radiation. Furthermore, the liquid-crystal materials should have low viscosity and produce short addressing times, low threshold voltages and high contrast in the cells.

They should furthermore have a suitable mesophase, for example a nematic or cholesteric mesophase for the above-mentioned cells, at the usual operating temperatures, i.e. in the broadest possible range above and below room temperature. Since liquid crystals are generally used as mixtures of a plurality of components, it is important that the components are readily miscible with one another. Further properties, such as the electrical conductivity, the dielectric anisotropy and the optical anisotropy, have to satisfy various requirements depending on the cell type and area of application. For example, materials for cells having a twisted nematic structure should have positive dielectric anisotropy and low electrical conductivity.

For example, for matrix liquid-crystal displays with integrated non-linear elements for switching individual pixels (MLC displays), media having large positive dielectric anisotropy, broad nematic phases, relatively low birefringence, very high specific resistance, good UV and temperature stability and low vapour pressure are desired.

Matrix liquid-crystal displays of this type are known. Examples of non-linear elements which can be used to individually switch the individual pixels are active elements (i.e. transistors). The term “active matrix” is then used, where a distinction can be made between two types:
1. MOS (metal oxide semiconductor) or other diodes on silicon wafers as substrate.
2. Thin-film transistors (TFTs) on a glass plate as substrate.

The use of single-crystal silicon as substrate material restricts the display size, since even modular assembly of various part-displays results in problems at the joints.

In the case of the more promising type 2, which is preferred, the electro-optical effect used is usually the TN effect. A distinction is made between two technologies: TFTs comprising compound semiconductors, such as, for example, CdSe, or TFTs based on polycrystalline or amorphous silicon. Intensive work is being carried out worldwide on the latter technology.

The TFT matrix is applied to the inside of one glass plate of the display, while the other glass plate carries the transparent counterelectrode on its inside. Compared with the size of the pixel electrode, the TFT is very small and has virtually no adverse effect on the image. This technology can also be extended to fully colour-capable displays, in which a mosaic of red, green and blue filters is arranged in such a way that a filter element is opposite each switchable pixel.

The TFT displays usually operate as TN cells with crossed polarisers in transmission and are backlit.

The term MLC displays here encompasses any matrix display with integrated non-linear elements, i.e., besides the active matrix, also displays with passive elements, such as varistors or diodes (MIM=metal-insulator-metal). MLC displays of this type are particularly suitable for TV applications (for example pocket televisions) or for high-information displays for computer applications (laptops) and in automobile or aircraft construction. Besides problems regarding the angle dependence of the contrast and the response times, difficulties also arise in MLC displays due to insufficiently high specific resistance of the liquid-crystal mixtures [TOGASHI, S., SEKIGUCHI, K., TANABE, H., YAMAMOTO, E., SORIMACHI, K., TAJIMA, E., WATANABE, H., SHIMIZU, H., Proc. Eurodisplay 84, September 1984: A 210-288 Matrix LCD Controlled by Double Stage Diode Rings, pp. 141 ff, Paris; STROMER, M., Proc. Eurodisplay 84, September 1984: Design of Thin Film Transistors for Matrix Addressing of Television Liquid Crystal Displays, pp. 145 if, Paris]. With decreasing resistance, the contrast of an MLC display deteriorates, and the problem of after-image elimination may occur. Since the specific resistance of the liquid-crystal mixture generally drops over the life of an MLC display owing to interaction with the interior surfaces of the display, a high (initial) resistance is very important in order to obtain acceptable lifetimes. In particular in the case of low-volt mixtures, it was hitherto impossible to achieve very high specific resistance values. It is furthermore important that the specific resistance exhibits the smallest possible increase with increasing temperature and after heating and/or UV exposure. The low-temperature properties of the mixtures from the prior art are also particularly disadvantageous. It is demanded that no crystallisation and/or smectic phases occur, even at low temperatures, and the temperature dependence of the viscosity is as low as possible. The MLC displays from the prior art thus do not satisfy today's requirements.

Besides liquid-crystal displays which use backlighting, i.e. are operated transmissively and if desired transfiectively, reflective liquid-crystal displays are also particularly interesting. These reflective liquid-crystal displays use the ambient light for information display. They thus consume significantly less energy than backlit liquid-crystal displays having a corresponding size and resolution. Since the TN effect is characterised by very good contrast, reflective displays of this type can even be read well in bright ambient conditions. This is already known of simple reflective TN displays, as used, for example, in watches and pocket calculators. However, the principle can also be applied to high-quality, higher-resolution active matrix-addressed displays, such as, for example, TFT displays. Here, as already in the transmissive TFT-TN displays which are generally conventional, the use of liquid crystals of low birefringence (Δn) is necessary in order to achieve low optical retardation (d·Δn). This low optical retardation results in usually acceptable low viewing-angle dependence of the contrast (cf. DE 30 22 818). In reflective displays, the use of liquid crystals of low birefringence is even more important than in transmissive displays since the effective layer thickness through which the light passes is approximately twice as large in reflective displays as in transmissive displays having the same layer thickness.

In order to achieve 3D effects by means of shutter spectacles, fast-switching mixtures having low rotational viscosities and correspondingly high optical anisotropy (Δn), in particular, are employed. Electro-optical lens systems, by means of which a 2-dimensional representation of a display can be switched to a 3-dimensional autostereoscopic representation, can be achieved using mixtures having high optical anisotropy (Δn).

Thus, there continues to be a great demand for MLC displays having very high specific resistance at the same time as a large working-temperature range, short response times, even at low temperatures, and a low threshold voltage which do not exhibit these disadvantages or only do so to a lesser extent.

In the case of TN (Schadt-Helfrich) cells, media are desired which facilitate the following advantages in the cells:
extended nematic phase range (in particular down to low temperatures)
switchability at extremely low temperatures (outdoor use, automobiles, avionics)
increased resistance to UV radiation (longer life)
low threshold voltage.

The media available from the prior art do not enable these advantages to be achieved while simultaneously retaining the other parameters. Modern LCD flat-panel screens require ever-faster response times in order to be able to reproduce multimedia content, such as, for example, films and video games, realistically. These in turn require nematic liquid-crystal mixtures which have a very low rotational viscosity γ₁ with high optical anisotropy Δn. In order to obtain the requisite rotational viscosities, substances are sought which have a particularly advantageous γ₁/clearing point ratio at the same time as high Δn with high polarity.

In the case of supertwisted (STN) cells, media are desired which facilitate greater multiplexability and/or lower threshold voltages and/or broader nematic phase ranges (in particular at low temperatures). To this end, a further widening of the available parameter latitude (clearing point, smectic-nematic transition or melting point, viscosity, dielectric parameters, elastic parameters) is urgently desired.

In particular in the case of LC displays for TV and video applications (for example LCD-TVs, monitors, PDAs, notebooks, games consoles), a significant reduction in the response times is desired. This requires LC mixtures having low rotational viscosities and high dielectric anisotropies. At the same time, the LC media should have a broad nematic phase and the lowest possible value of the smectic-nematic phase-transition temperature or melting point.

The invention has the object of providing media, in particular for MLC, TN, STN, ECB, OCB, IPS, PS-IPS, FFS, PS-FFS or positive VA displays of this type, which do not exhibit the disadvantages indicated above or only do so to a lesser extent and preferably have fast response times and low rotational viscosities at the same time as a high clearing point, as well as high dielectric anisotropy and a low threshold voltage.

It has now been found that this object can be achieved if LC media as described below are used.

The invention relates to a liquid-crystalline medium, characterised in that it comprises

one or more compounds of the formula 1,

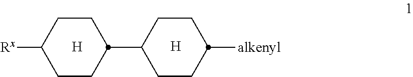

and one or more compounds of the formula 2,

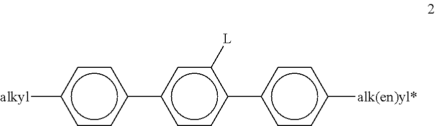

and one or more compounds selected from the compounds of the formulae 3, 4 and 5,

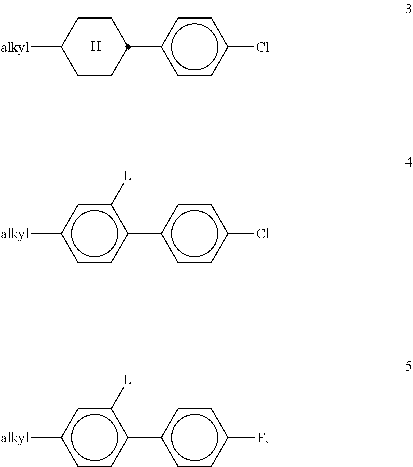

in which the individual radicals, in each case independently of one another and identically or differently on each occurrence, have the following meanings:
alkenyl denotes C₂₋₆-alkenyl,
R^{x} denotes C₁₋₆-alkyl or C₂₋₆-alkenyl,
alkyl and alkyl* each, independently of one another, denote C₁₋₆-alkyl,
L denotes H or F,
alk(en)yl* denotes C₁₋₆-alkyl or C₂₋₆-alkenyl.

Surprisingly, it has been found that LC media comprising one or more compounds selected from the formulae 1-5 have high dielectric anisotropy Δε, high birefringence Δn, low rotational viscosity γ₁ and a low smectic-nematic phase-transition temperature or melting point. They are therefore particularly suitable for achieving liquid-crystal mixtures having low γ₁ and high Δn. In addition, the compounds of the formulae 1-5 exhibit good solubility and very good phase behaviour in LC media.

LC media according to the invention comprising compounds of the formulae 1-5 have low rotational viscosity, fast response times, a high clearing point, very high positive dielectric anisotropy, relatively high birefringence and a broad nematic phase range. They are therefore particularly suitable for mobile telephones, TV and video applications.

The compounds of the formulae 1-5 have a broad range of applications. Depending on the choice of substituents, they can serve as base materials of which liquid-crystalline media are predominantly composed; however, liquid-crystalline base materials from other classes of compound can also be added to the compounds of the formulae 1-5 in order, for example, to modify the dielectric and/or optical anisotropy of a dielectric of this type and/or to optimise its threshold voltage and/or its viscosity.

The compounds of the formulae 1-5 have relatively low melting points, exhibit good phase behaviour, are colourless in the pure state and form liquid-crystalline mesophases in a temperature range which is favourably located for electro-optical use. They are stable chemically, thermally and to light.

In the formulae above and below, an alkyl radical may be straight-chain or branched. It is preferably straight-chain, has 2, 3, 4, 5, 6 or 7 C atoms and accordingly preferably denotes ethyl, propyl, butyl, pentyl, hexyl, heptyl, ethoxy, propoxy, butoxy, pentoxy, hexyloxy or heptyloxy, furthermore methyl, octyl, nonyl, decyl, undecyl, dodecyl, tridecyl, tetradecyl, pentadecyl, methoxy, octyloxy, nonyloxy, decyloxy, undecyloxy, dodecyloxy, tridecyloxy or tetradecyloxy. R^{A} and R^{B} each preferably denote straight-chain alkyl having 2-6 C atoms.

Oxaalkyl preferably denotes straight-chain 2-oxapropyl (=methoxymethyl), 2- (=ethoxymethyl) or 3-oxabutyl (=2-methoxyethyl), 2-, 3- or 4-oxapentyl, 2-, 3-, 4- or 5-oxahexyl, 2-, 3-, 4-, 5- or 6-oxaheptyl, 2-, 3-, 4-, 5-, 6- or 7-oxaoctyl, 2-, 3-, 4-, 5-, 6-, 7- or 8-oxanonyl, 2-, 3-, 4-, 5-, 6-, 7-, 8- or 9-oxadecyl.

An alkenyl radical may be straight-chain or branched. It is preferably straight-chain and has 2 to 10 C atoms. Accordingly, it denotes, in particular, vinyl, prop-1- or -2-enyl, but-1-, -2- or -3-enyl, pent-1-, -2-, -3- or -4-enyl, hex-1-, -2-, -3-, -4- or -5-enyl, hept-1-, -2-, -3-, -4-, -5- or -6-enyl, oct-1-, -2-, -3-, -4-, -5-, -6- or -7-enyl, non-1-, -2-, -3-, -4-, -5-, -6-, -7- or -8-enyl, dec-1-, -2-, -3-, -4-, -5-, -6-, -7-, -8- or -9-enyl.

If an alkyl or alkenyl radical is at least monosubstituted by halogen, this radical is preferably straight-chain, and halogen is preferably F or Cl. In the case of polysubstitution, halogen is preferably F. The resultant radicals also include perfluorinated radicals. In the case of monosubstitution, the fluorine or chlorine substituent may be in any desired position, but is preferably in the co-position.

In the formulae above and below, X⁰ is preferably F, Cl or a mono- or polyfluorinated alkyl or alkoxy radical having 1, 2 or 3 C atoms or a mono- or polyfluorinated alkenyl radical having 2 or 3 C atoms. X⁰ is particularly preferably F, Cl, CF₃, CHF₂, OCF₃, OCHF₂, OCFHCF₃, OCFHCHF₂, OCFHCHF₂, OCF₂CH₃, OCF₂CHF₂, OCF₂CHF₂, OCF₂CF₂CHF₂, OCF₂CF₂CHF₂, OCFHCF₂CF₃, OCFHCF₂CHF₂, OCF₂CF₂CF₃, OCF₂CF₂CCIF₂, OCCIFCF₂CF₃, OCH═CF₂ or CH═CF₂, very particularly preferably F or OCF₃, furthermore CF₃, OCF═CF₂, OCHF₂ or OCH═CF₂.

Particular preference is given to compounds of the formula 1 in which “alkenyl” denotes vinyl, prop-1-enyl, prop-2-enyl or but-3-enyl.

Preference is furthermore given to compounds of the formula 1 in which R^{x} denotes methyl, ethyl, n-propyl, n-butyl or n-pentyl.

Particular preference is given to compounds of the formula 2 in which L denotes F.

Preference is furthermore given to compounds of the formula 2 in which “alkyl” denotes methyl, ethyl, n-propyl, n-butyl or n-pentyl.

Preference is furthermore given to compounds of the formula 2 in which “alkenyl” denotes vinyl, prop-1-enyl, prop-2-enyl or but-3-enyl, particularly preferably but-3-enyl.

Particular preference is given to compounds of the formula 4 in which L denotes F.

Particular preference is given to compounds of the formula 5 in which L denotes H.

Preference is furthermore given to compounds of the formulae 3, 4 and 5 in which “alkyl” denotes ethyl, n-propyl or n-pentyl.

The compounds of the formula 1 are preferably selected from the following formulae:

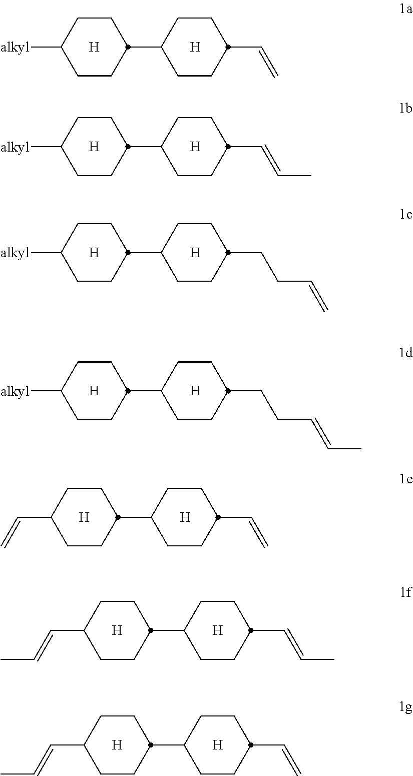

in which “alkyl” has the meaning indicated in formula 1 and particularly preferably denotes methyl, ethyl, n-propyl, n-butyl or n-pentyl.

Particular preference is given to compounds of the formulae 1a and 1b, in particular those in which “alkyl” denotes n-propyl.

The compounds of the formula 2 are preferably selected from the following formulae:

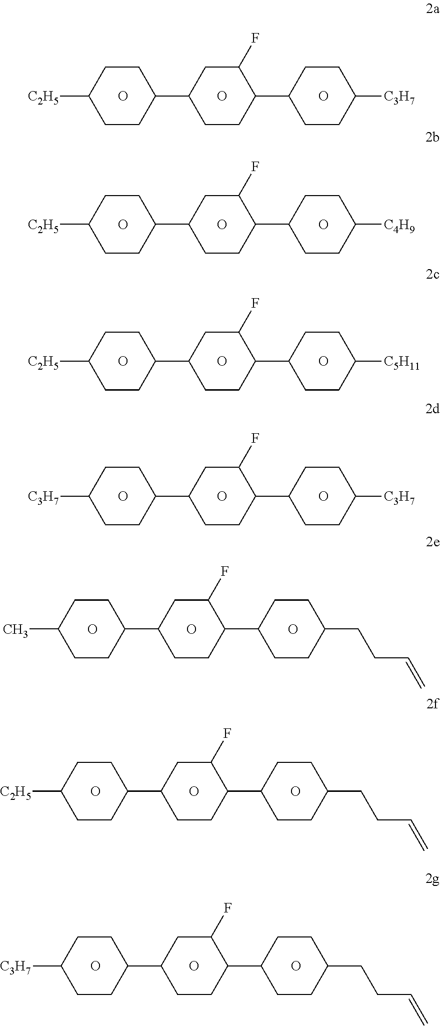

The compounds of the formula 3 are preferably selected from the following formulae:

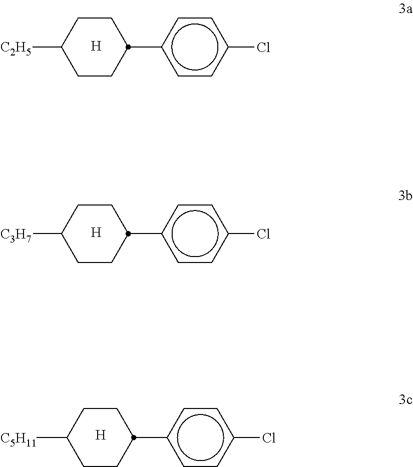

Particular preference is given to compounds of the formula 3b.

The compounds of the formula 4 are preferably selected from the following formulae:

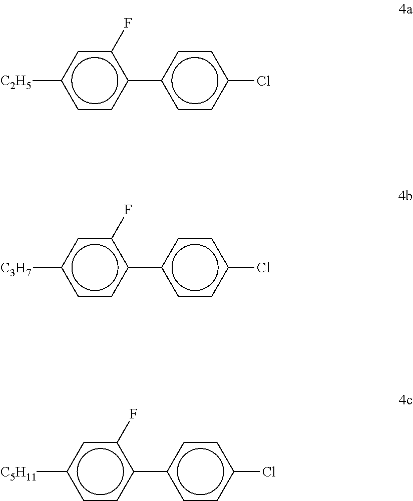

Particular preference is given to compounds of the formula 4b.

The compounds of the formula 5 are preferably selected from the following formulae:

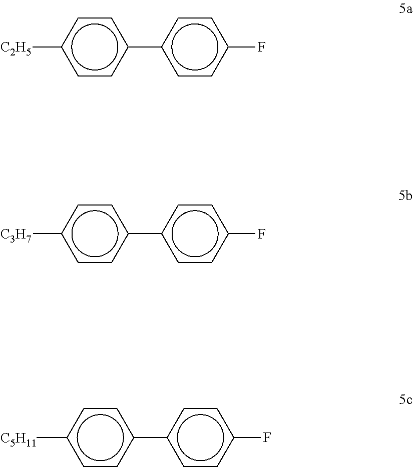

Particular preference is given to compounds of the formula 5c.

Particularly preferred media are described below:

Medium comprising in each case one or more compounds of the formulae 1, 2 and 3.

Medium comprising in each case one or more compounds of the formulae 1, 2 and 4.

Medium comprising in each case one or more compounds of the formulae 1, 2 and 5.

Medium comprising one or more compounds of formula 1, one or more compounds of the formula 2 and one or more compounds of the formula 3 or 5.

Medium comprising one or more compounds selected from the formulae 1a and 1b, two or more compounds selected from the formulae 2a to 2d, and a compound of the formula 3b or 4b or 5c.

Medium comprising

one or more compounds selected from the formulae 1a and 1b, two or more compounds selected from the formulae 2a to 2d, and a compound of the formula 3b or 5c.

The proportion of compounds of the formula 1 in the mixture as a whole is preferably 20 to 65% by weight, particularly preferably 25 to 60% by weight.

The proportion of compounds of the formula 2 in the mixture as a whole is preferably 5 to 35% by weight, particularly preferably 5 to 25% by weight.

The proportion of compounds of the formula 3 in the mixture as a whole is preferably 2 to 20% by weight, particularly preferably 2 to 15% by weight.

The proportion of compounds of the formula 4 in the mixture as a whole is preferably 2 to 20% by weight, particularly preferably 2 to 15% by weight.

The proportion of compounds of the formula 5 in the mixture as a whole is preferably 2 to 20% by weight, particularly preferably 2 to 15% by weight.

Particular preference is given to media comprising
20 to 65% by weight of one or more compounds of the formula 1, preferably selected from the formulae 1a and 1b, and
5 to 30% by weight of one or more compounds of the formula 2, preferably selected from the formulae 2a, 2b, 2c and 2d, and
2 to 20% by weight of one or more compounds selected from the formulae 3, 4 and 5, preferably selected from the formulae 3b, 4b and 5c.

The compounds of the formulae 1-5 are prepared by methods known per se, as described in the literature (for example in the standard works, such as Houben-Weyl, Methoden der Organischen Chemie (Methods of Organic Chemistry], Georg-Thieme-Verlag, Stuttgart), to be precise under reaction conditions which are known and suitable for the said reactions. Use can also be made here of variants known per se which are not mentioned in greater detail here.

Preferred embodiments for the mixtures according to the invention are indicated below:
The medium additionally comprises one or more compounds of the formulae II and/or III

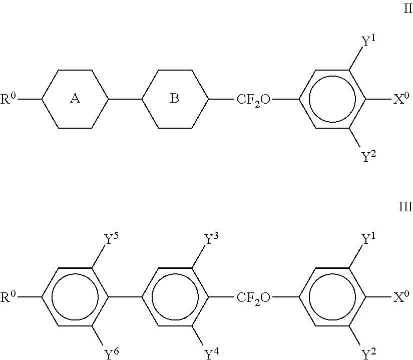

in which
R⁰ denotes unsubstituted or halogenated alkyl or alkoxy having 1 to 15 C atoms, cyclopentyl or cyclobutyl, where, in addition, one or more CH₂ groups in these radicals may each be replaced, independently of one another, by —C≡C—, —CF₂O—, —CH═CH—,

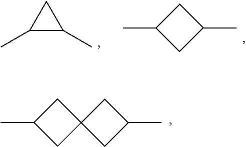

—O—, —CO—O— or —O—CO— in such a way that O atoms are not linked directly to one another,
X⁰ denotes F, Cl, halogenated alkyl, halogenated alkoxy, halogenated alkenyl or halogenated alkenyloxy, each having up to 6 C atoms,
Y¹⁻⁶ each, independently of one another, denote H or F,

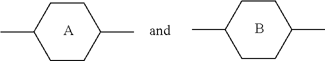

each, independently of one another, denote

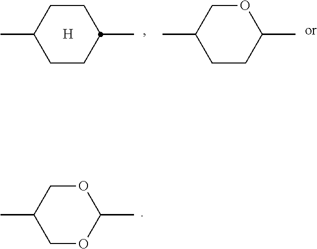

The compounds of the formula II are preferably selected from the following formulae:

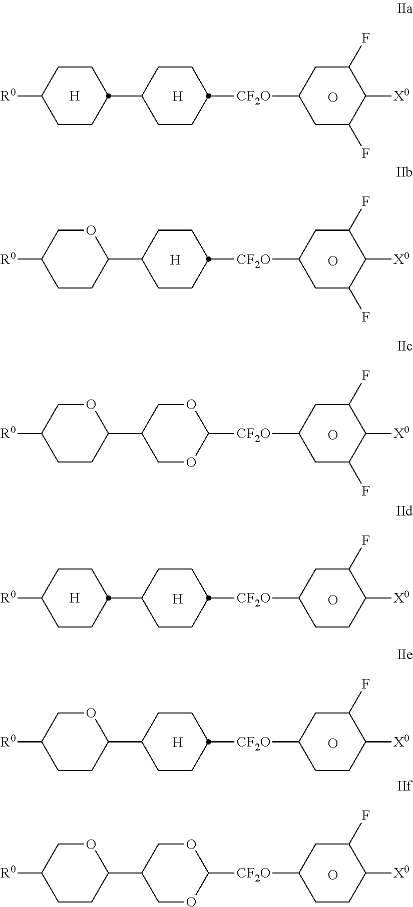

in which R⁰ and X⁰ have the meanings indicated above.
R⁰ preferably denotes alkyl having 1 to 6 C atoms or cyclopentyl. X⁰ preferably denotes F. Particular preference is given to compounds of the formulae IIa and IIb, in particular compounds of the formulae IIa and IIb in which X⁰ denotes F.
The compounds of the formula III are preferably selected from the following formulae:

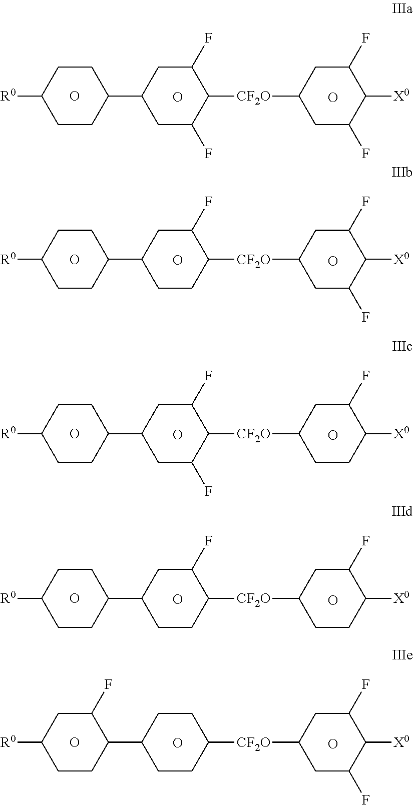

in which R⁰ and X⁰ have the meanings indicated above.
R⁰ preferably denotes alkyl having 1 to 6 C atoms or cyclopentyl. X⁰ preferably denotes F. Particular preference is given to compounds of the formulae IIIa and IIIa, in particular of the formula IIIa;
The medium additionally comprises one or more compounds selected from the following formulae:

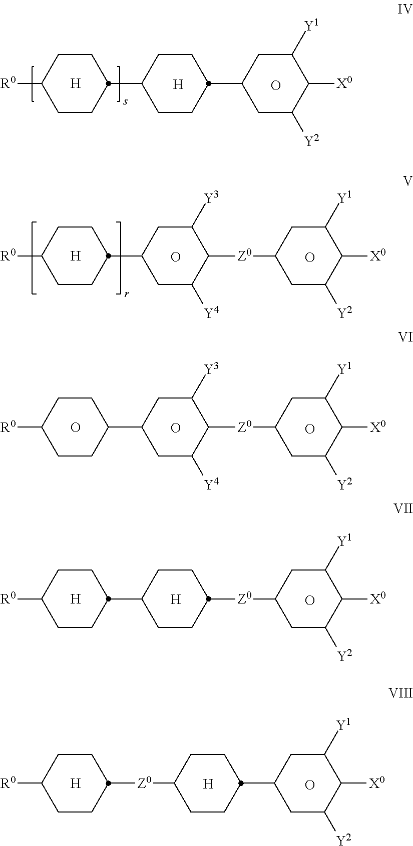

in which
R⁰, X⁰ and Y¹⁻⁴ have the meanings indicated above, and
Z⁰ denotes —C₂H₄—, —(CH₂)₄—, —CH═CH—, —CF═CF—, —C₂F₄—, —CH₂CF₂—, —CF₂CH₂—, —CH₂O—, —OCH₂—, —COO— or —OCF₂—, in formulae V and VI also a single bond, in formulae V and VIII also —CF₂O—,
r denotes 0 or 1, and
s denotes 0 or 1;
The compounds of the formula IV are preferably selected from the following formulae:

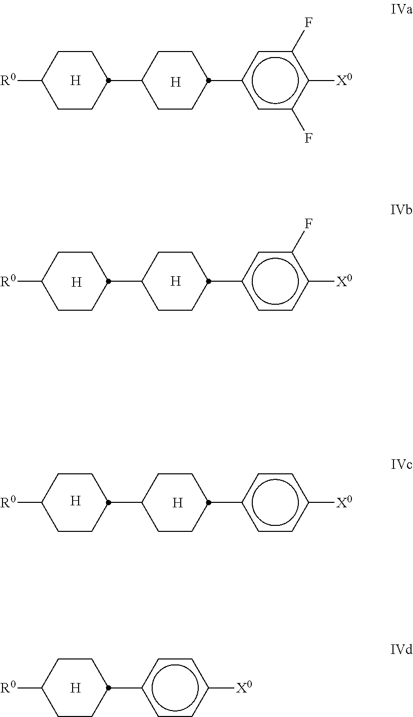

in which R⁰ and X⁰ have the meanings indicated above.
R⁰ preferably denotes alkyl having 1 to 6 C atoms or cyclopentyl. X⁰ preferably denotes F or OCF₃, furthermore OCF═CF₂, CF₂ and Cl;
The compounds of the formula V are preferably selected from the following formulae:

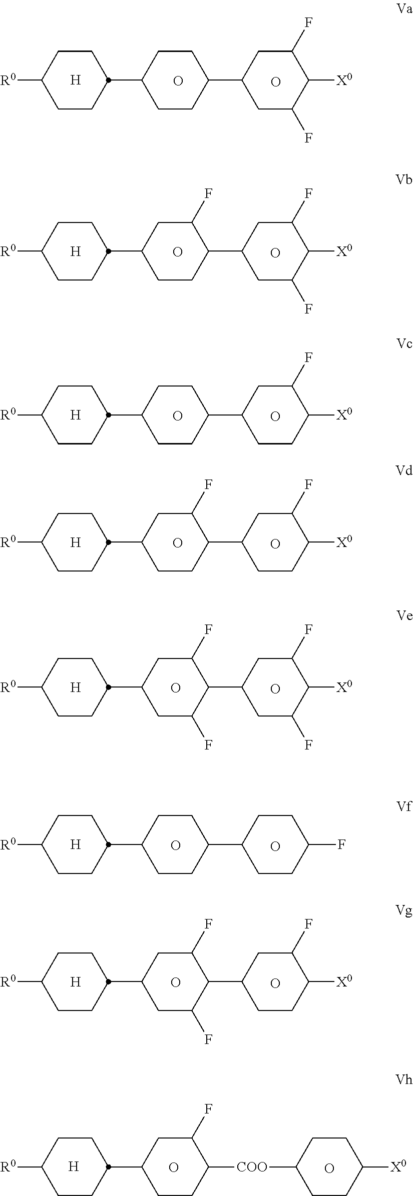

in which R⁰ and X⁰ have the meanings indicated above.
R⁰ preferably denotes alkyl having 1 to 6 C atoms or cyclopentyl. X⁰ preferably denotes F and OCF₃, furthermore OCHF₂, CF₃, OCF═CF₂ and OCH═CF₂;
The compounds of the formula VI are preferably selected from the following formulae:

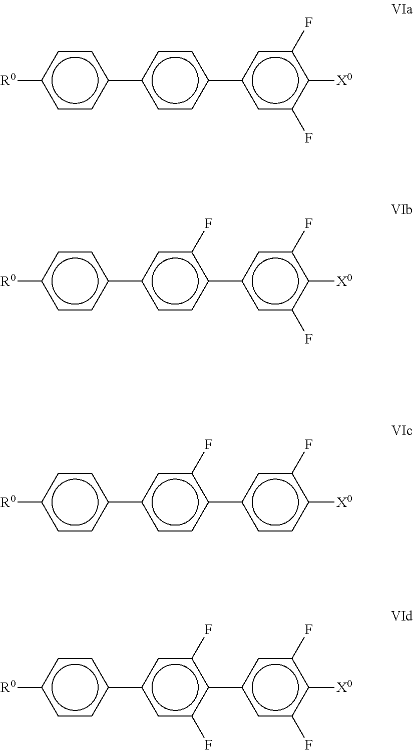

in which R⁰ and X⁰ have the meanings indicated above.
R⁰ preferably denotes alkyl having 1 to 6 C atoms or cyclopentyl. X⁰ preferably denotes F, furthermore OCF₃, CF₃, CF═CF₂, OCHF₂ and OCH═CF₂;
The compounds of the formula VII are preferably selected from the following formulae:

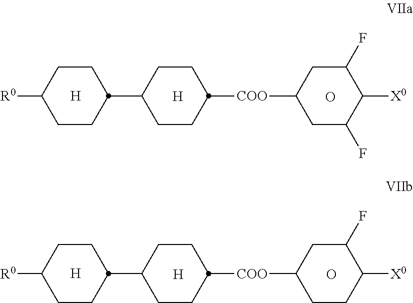

in which R⁰ and X⁰ have the meanings indicated above.
R⁰ preferably denotes alkyl having 1 to 6 C atoms or cyclopentyl. X⁰ preferably denotes F, furthermore OCF₃, CF₃, OCHF₂ and OCH═CF₂.
The medium additionally comprises one or more compounds selected from the following formulae:

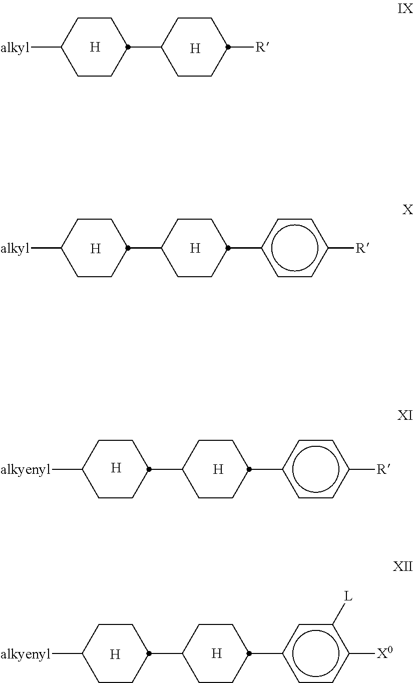

in which X⁰ has the meanings indicated above, and
L denotes H or F,
“alkyl” denotes C₁₋₆-alkyl,
R′ denotes C₁₋₆-alkyl, C₁₋₆-alkoxy or C₂₋₆-alkenyl, and
“alkenyl” and “alkenyl*” each, independently of one another, denote C₂₋₆-alkenyl.
The compounds of the formulae IX-XII are preferably selected from the following formulae:

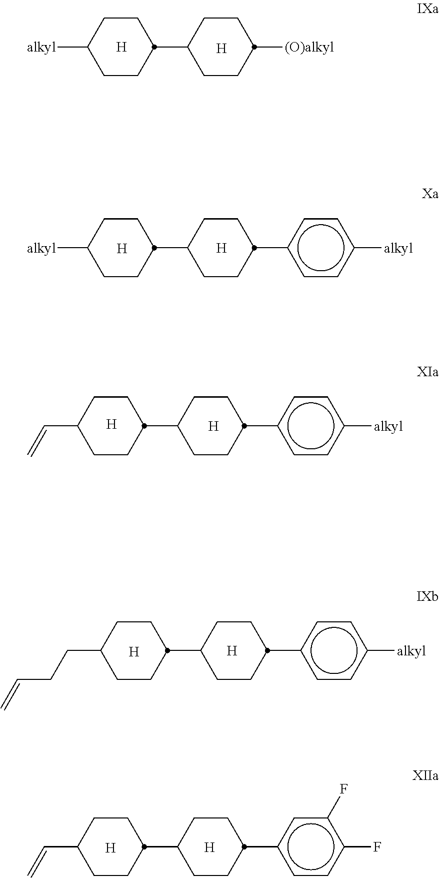

in which “alkyl” has the meaning indicated above. (O)alkyl means “alkyl” or “Oalkyl” (=alkoxy)
The medium additionally comprises one or more compounds selected from the following formulae:

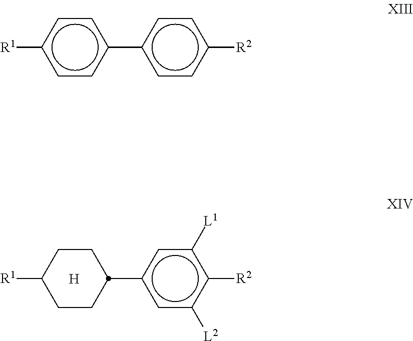

in which L¹ and L² each, independently of one another, denote H or F. R¹ and R² each, independently of one another, denote n-alkyl, alkoxy, oxaalkyl, fluoroalkyl or alkenyl, each having up to 6 C atoms, and preferably each, independently of one another, denote alkyl having 1 to 6 C atoms; in the compound of the formula XIII, at least one of the radicals R¹ and R² preferably denotes alkenyl having 2 to 6 C atoms.
The medium comprises one or more compounds of the formula XIII in which at least one of the radicals R¹ and R² denotes alkenyl having 2 to 6 C atoms, preferably those selected from the following formulae:

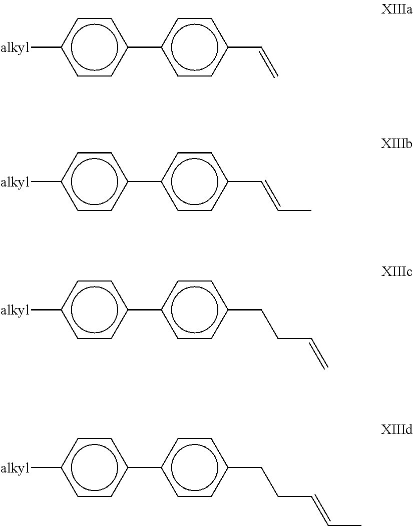

in which “alkyl” has the meaning indicated above, and preferably denotes methyl or ethyl. Particular preference is given to compounds of the formula XIIId.
The medium comprises one or more compounds of the following formulae:

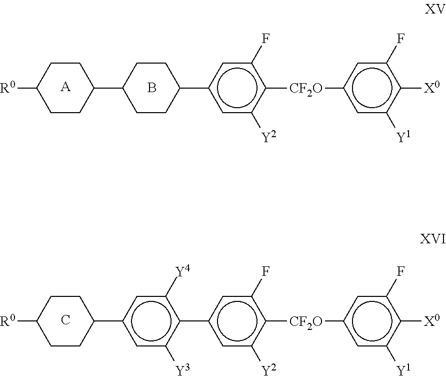

in which R⁰, X⁰ and Y¹⁻⁴ have the meanings indicated in formula I, and

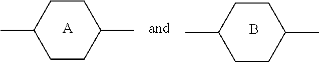

each, independently of one another, denote

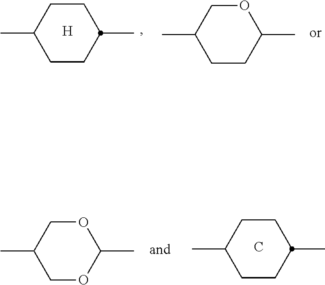

denotes

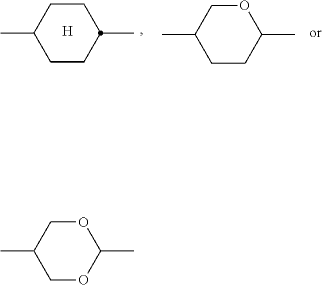

The compounds of the formulae XV and XVI are preferably selected from the following formulae:

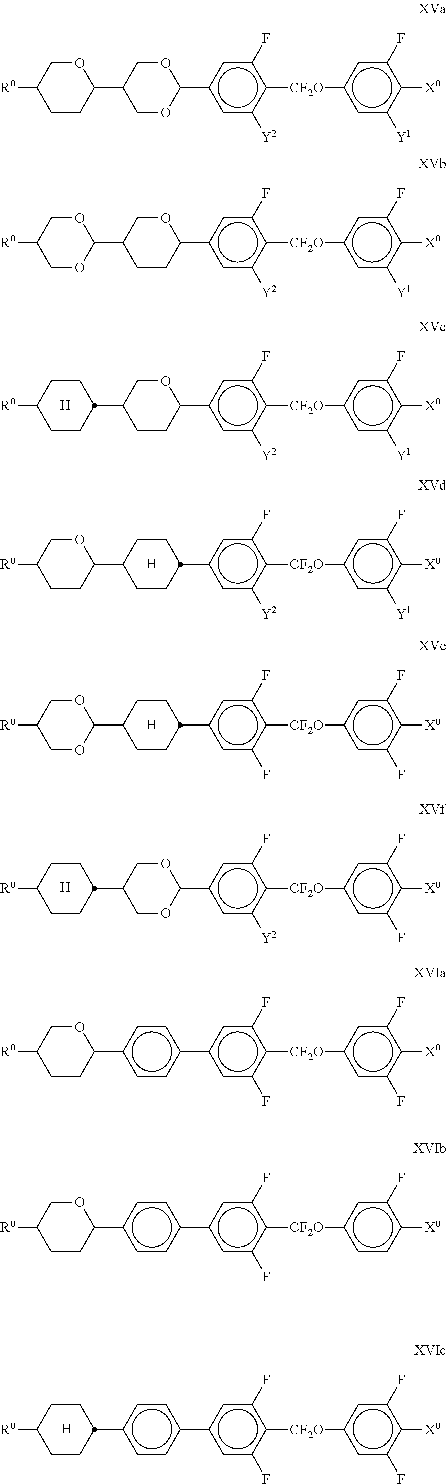

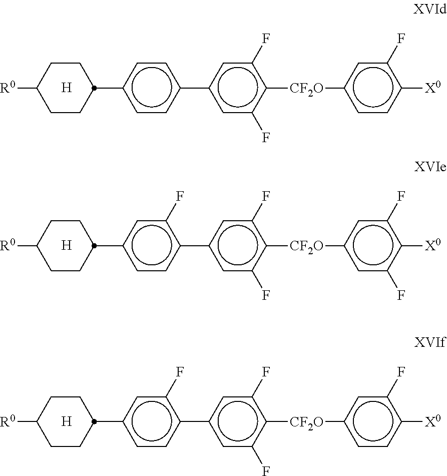

in which R⁰ and X⁰ have the meanings indicated above.
R⁰ preferably denotes alkyl having 1 to 6 C atoms. X⁰ preferably denotes F, furthermore OCF₃. Particularly preferred compounds of the formulae XV and XVI and the sub-formulae thereof are those in which Y¹ denotes F and Y² denotes H or F, preferably F. The mixture according to the invention particularly preferably comprises at least one compound of the formula XVa, XVf and/or XVIa.
The medium comprises one or more compounds of the formula XVII,

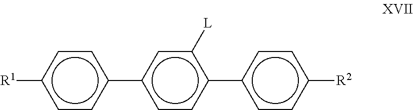

in which
R¹ denotes C₂₋₆-alkenyl,
R² denotes C₁₋₆-alkyl and C₂₋₆-alkenyl, and
L denotes H or F, preferably F
Particularly preferred compounds of the formula XVII are those of the sub-formulae

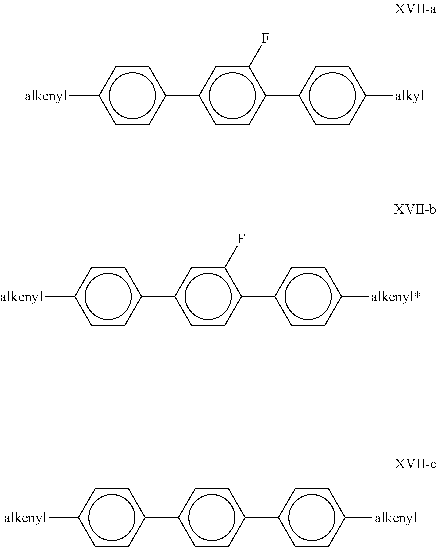

in which
alkyl denotes a straight-chain alkyl radical having 1-6 C atoms, in particular ethyl, propyl and pentyl,
alkenyl
and alkenyl* each, independently of one another, denote a straight-chain alkenyl radical having 2-6 C atoms, in particular CH₂═CHC₂H₄, CH₃CH═CHC₂H₄, CH₂═CH and CH₃CH═CH.
The medium additionally comprises one or more compounds of the following formulae:

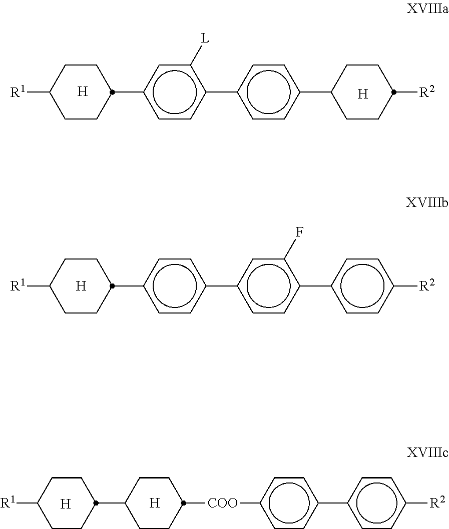

in which
R¹ and R² each, independently of one another, denote unsubstituted or halogenated alkyl or alkoxy having 1 to 15 C atoms, cyclopentyl or cyclobutyl, where, in addition, one or more CH₂ groups in these radicals may each be replaced, independently of one another, by —C≡C—, —CF₂O—, —CH═CH—,

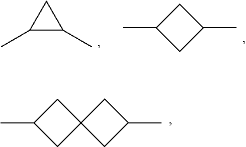

—O—, —CO—O— or —O—CO— in such a way that O atoms are not linked directly to one another,
and preferably each, independently of one another, denote alkyl having 1 to 6 C atoms. L denotes H or F;
The medium additionally comprises one or more compounds selected from the following formulae:

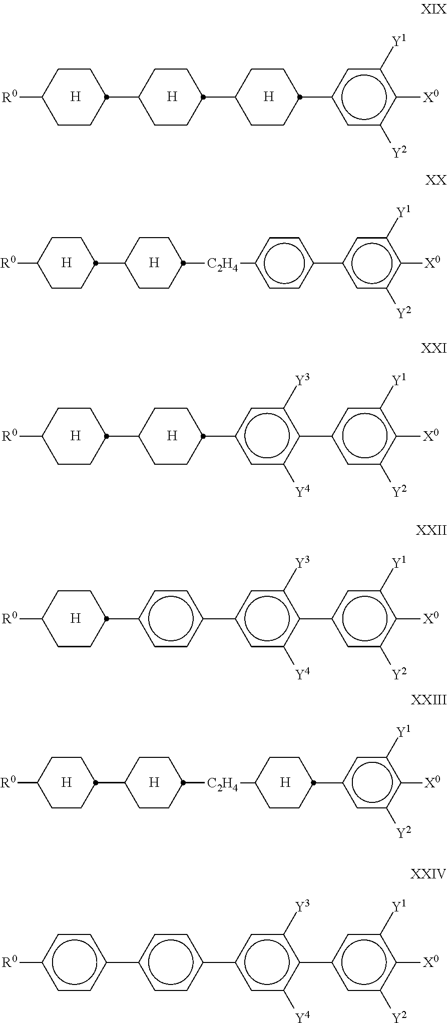

in which R⁰ and X⁰ each, independently of one another, have one of the meanings indicated above, and Y¹⁻⁴ each, independently of one another, denote H or F. X⁰ is preferably F, Cl, CF₃, OCF₃ or OCHF₂. Ro preferably denotes alkyl, alkoxy, oxaalkyl, fluoroalkyl or alkenyl, each having up to 6 C atoms.
The medium comprises one or more compounds of the formula XXIV-a,

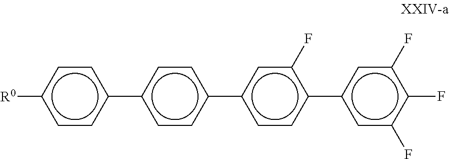

in which R⁰ has the meanings indicated above. R⁰ preferably denotes straight-chain alkyl, in particular ethyl, n-propyl, n-butyl and n-pentyl and very particularly preferably n-propyl. The compound(s) of the formula XXIV, in particular of the formula XXIV-a, is (are) preferably employed in the mixtures according to the invention in amounts of 0.5-20% by weight, particularly preferably 1-15% by weight.
The medium comprises one or more compounds of the formulae XXIa and/or XXIIa,

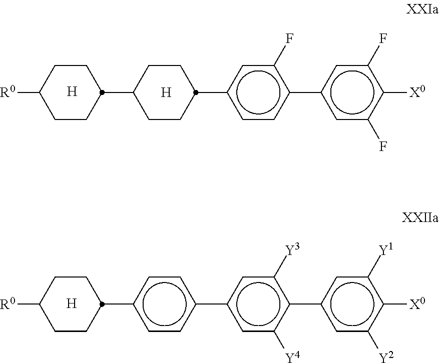

in which R⁰ and X⁰ have the meanings indicated above. R⁰ preferably denotes straight-chain alkyl, in particular ethyl, n-propyl, n-butyl and n-pentyl, and very particularly preferably n-propyl. X⁰ is preferably F or OCF₃.
The medium additionally comprises one or more compounds of the formula XXIV,

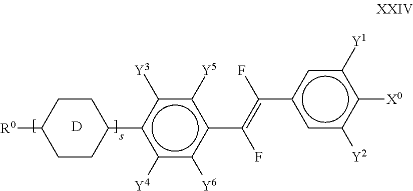

in which R⁰, X⁰ and Y¹⁻⁶ have the meanings indicated in Claim 9,
s denotes 0 or 1, and

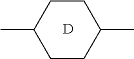

denotes

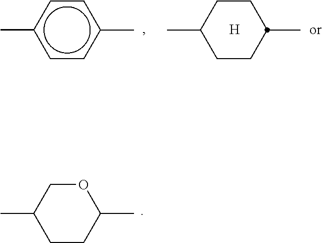

In the formula XXIV, X⁰ may also denote an alkyl radical having 1-6 C atoms or an alkoxy radical having 1-6 C atoms. The alkyl or alkoxy radical is preferably straight-chain.
R⁰ preferably denotes alkyl having 1 to 6 C atoms. X⁰ preferably denotes F;
The compounds of the formula XXIV are preferably selected from the following formulae:

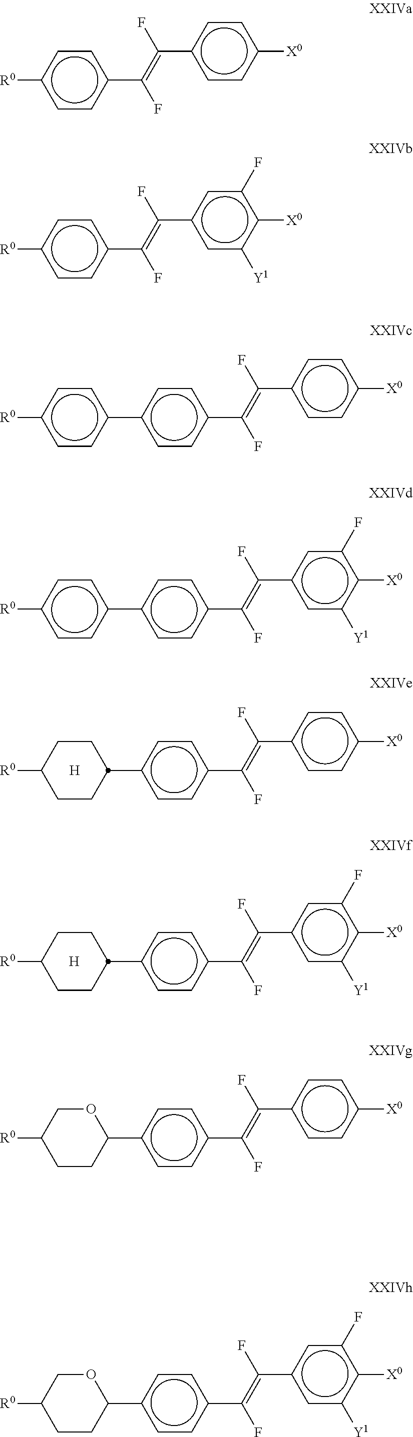

in which Ro, X⁰ and Y¹ have the meanings indicated above. R⁰ preferably denotes alkyl having 1 to 6 C atoms. X⁰ preferably denotes F, and Y¹ is preferably F;

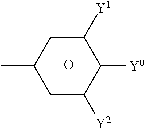

is preferably

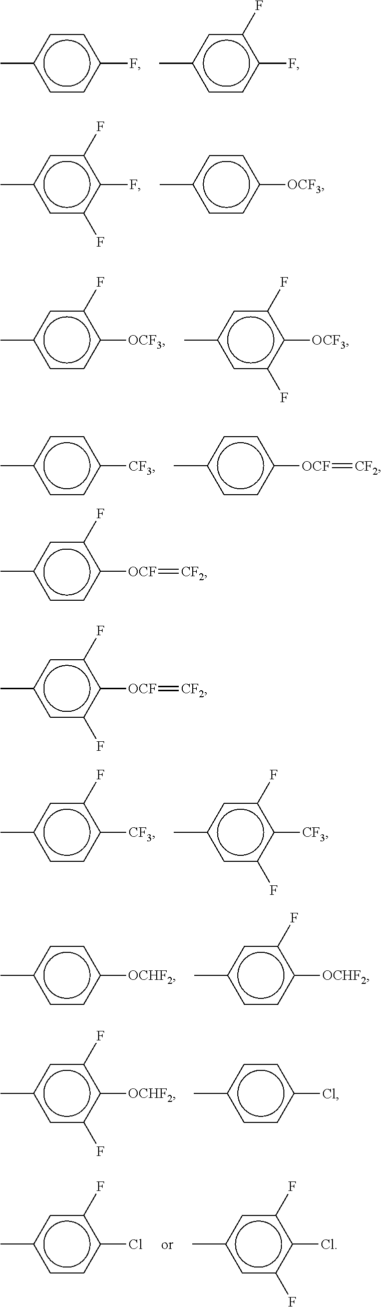

R⁰ is straight-chain alkyl or alkenyl having 2 to 6 C atoms;
The medium comprises one or more compounds of the following formulae:

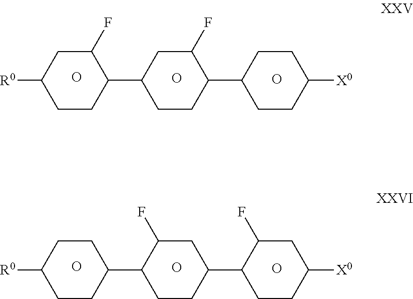

in which R⁰ and X⁰ have the meanings indicated above. R⁰ preferably denotes alkyl having 1 to 6 C atoms. X⁰ preferably denotes F or Cl. In the formula XXV, X⁰ very particularly preferably denotes CI.
The medium comprises one or more compounds of the following formulae:

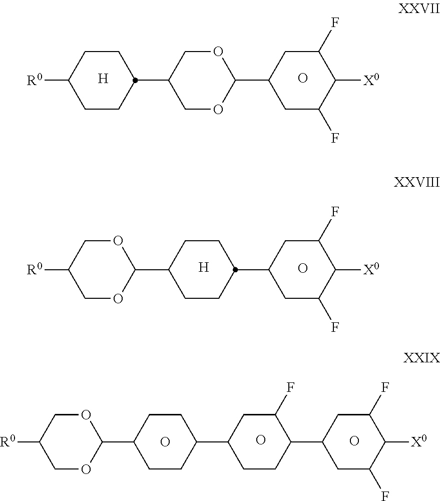

in which R⁰ and X⁰ have the meanings indicated above. R⁰ preferably denotes alkyl having 1 to 6 C atoms. X⁰ preferably denotes F. The medium according to the invention particularly preferably comprises one or more compounds of the formula XXIX in which X⁰ preferably denotes F. The compound(s) of the formulae XXVII-XXIX is (are) preferably employed in the mixtures according to the invention in amounts of 1-20% by weight, particularly preferably 1-15% by weight. Particularly preferred mixtures comprise at least one compound of the formula XXIX.
The medium comprises one or more compounds of the following formula:

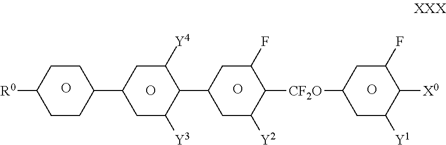

in which R⁰, X⁰ and Y¹⁻⁴ have the meanings indicated in formula II. R⁰ preferably denotes alkyl having 1 to 6 C atoms. X⁰ preferably denotes F.
The compounds of the formula XXX are preferably selected from the following formulae:

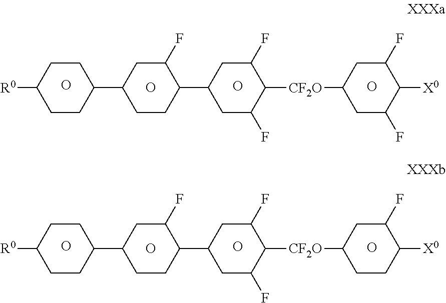

in which R⁰ and X⁰ have the meanings indicated above. R⁰ preferably denotes alkyl having 1 to 6 C atoms. X⁰ preferably denotes F.

Further preferred embodiments are indicated below:
The proportion of compounds of the formulae II, III, IX-XIII, XVII and XVIII in the mixture as a whole is 40 to 95% by weight;
The medium comprises 10-50% by weight, particularly preferably 12-40% by weight, of compounds of the formulae II and/or III;
The medium comprises 20-70% by weight, particularly preferably 25-65% by weight, of compounds of the formulae IX-XIII;
The medium comprises 4-30% by weight, particularly preferably 5-20% by weight, of compounds of the formula XVII;
The medium comprises 1-20% by weight, particularly preferably 2-15% by weight, of compounds of the formula XVIII;
The medium comprises ≥20% by weight, preferably ≥24% by weight, preferably 25-60% by weight, of compounds of the formula 1, in particular the compound of the formula 1a1,

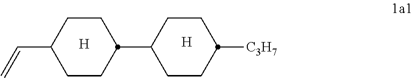

The medium comprises at least one compound of the formula 1a or 1a1 and at least one compound of the formula 1b1,

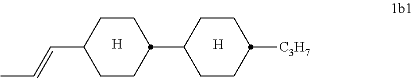

The medium comprises at least one compound selected from the following formulae:

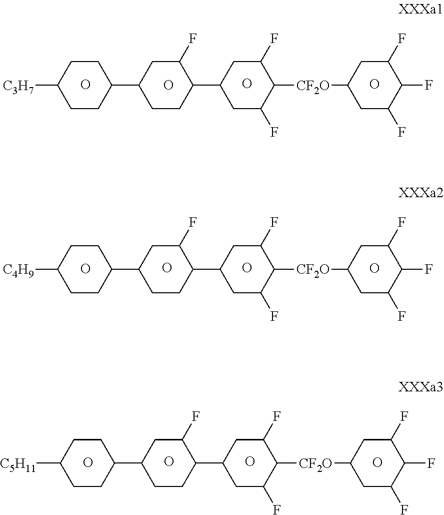

The medium comprises at least one compound selected from the following formulae:

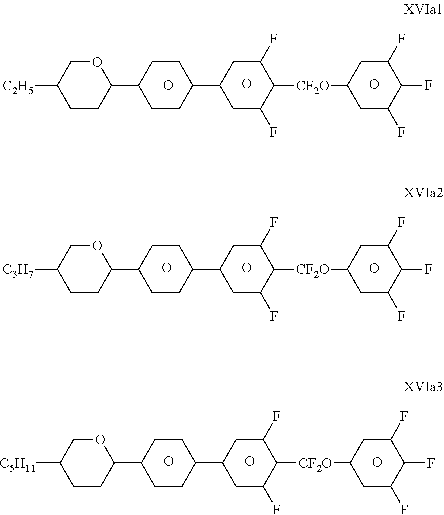

The medium comprises at least one compound selected from the following formulae:

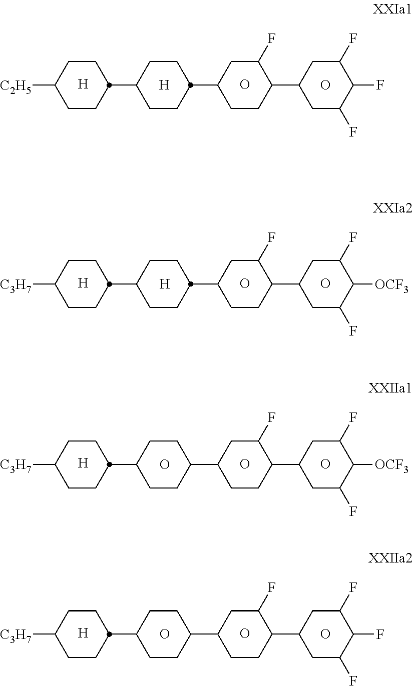

The medium comprises at least one compound, preferably two or three compounds, of the formulae PGP-n-m and/or PGP-n-2V, in which n and m each, independently of one another, denote 2, 3, 4 or 5.

It has been found that the use of compounds of the formulae 1-5 as described above in a mixture with conventional liquid-crystal materials, but in particular with one or more compounds of the formulae II to XXX, results in a significant increase in the light stability and in relatively high birefringence values, with broad nematic phases with low smectic-nematic transition temperatures being observed at the same time, improving the shelf life. At the same time, the mixtures exhibit very low threshold voltages, very good values for the VHR on exposure to UV, and very high clearing points.

The term “alkyl” or “alkyl*” in this application encompasses straight-chain and branched alkyl groups having 1-6 carton atoms, in particular the straight-chain groups methyl, ethyl, propyl, butyl, pentyl and hexyl. Groups having 2-5 carbon atoms are generally preferred.

The term “alkenyl” or “alkenyl*” encompasses straight-chain and branched alkenyl groups having 2-6 carton atoms, in particular the straight-chain groups. Preferred alkenyl groups are C₂-C₇-1E-alkenyl, C₄-C₆-3E-alkenyl, in particular C₂-C₆-1E-alkenyl. Examples of particularly preferred alkenyl groups are vinyl, 1E-propenyl, 1E-butenyl, 1E-pentenyl, 1E-hexenyl, 3-butenyl, 3E-pentenyl, 3E-hexenyl, 4-pentenyl, 4Z-hexenyl, 4E-hexenyl and 5-hexenyl. Groups having up to 5 carbon atoms are generally preferred, in particular CH₂═CH, CH₃CH═CH.

The term “fluoroalkyl” preferably encompasses straight-chain groups having a terminal fluorine, i.e. fluoromethyl, 2-fluoroethyl, 3-fluoropropyl, 4-fluorobutyl, 5-fluoropentyl, 6-fluorohexyl and 7-fluoroheptyl. However, other positions of the fluorine are not excluded.

The term “oxaalkyl” or “alkoxy” preferably encompasses straight-chain radicals of the formula CₙH₂ₙ₊₁—O—(CH₂)ₘ, in which n and m each, independently of one another, denote 1 to 6. m may also denote 0. Preferably, n=1 and m=1-6 or m=0 and n=1-3.

Through a suitable choice of the meanings of R⁰ and X⁰, the addressing times, the threshold voltage, the steepness of the transmission characteristic lines, etc., can be modified in the desired manner. For example, 1E-alkenyl radicals, 3E-alkenyl radicals, 2E-alkenyloxy radicals and the like generally result in shorter addressing times, improved nematic tendencies and a higher ratio between the elastic constants k₃₃ (bend) and k₁₁ (splay) compared with alkyl and alkoxy radicals. 4-Alkenyl radicals, 3-alkenyl radicals and the like generally give lower threshold voltages and lower values of k₃₃/k₁₁ compared with alkyl and alkoxy radicals. The mixtures according to the invention are distinguished, in particular, by high Δε values and thus have significantly faster response times than the mixtures from the prior art.

The optimum mixing ratio of the compounds of the above-mentioned formulae depends substantially on the desired properties, on the choice of the components of the above-mentioned formulae and on the choice of any further components that may be present.

Suitable mixing ratios within the range indicated above can easily be determined from case to case.

The total amount of compounds of the above-mentioned formulae in the mixtures according to the invention is not crucial. The mixtures can therefore comprise one or more further components for the purposes of optimisation of various properties. However, the observed effect on the desired improvement in the properties of the mixture is generally greater, the higher the total concentration of compounds of the above-mentioned formulae.

In a particularly preferred embodiment, the media according to the invention comprise compounds of the formulae II to VIII (preferably II, III, IV and V, in particular IIa and IIa) in which X⁰ denotes F, OCF₃, OCHF₂, OCH═CF₂, OCF═CF₂ or OCF₂—CF₂H.

The individual compounds of the above-mentioned formulae and the sub-formulae thereof which can be used in the media according to the invention are either known or can be prepared analogously to the known compounds.

The invention also relates to electro-optical displays, such as, for example, STN or MLC displays, having two plane-parallel outer plates, which, together with a frame, form a cell, integrated non-linear elements for switching individual pixels on the outer plates, and a nematic liquid-crystal mixture having positive dielectric anisotropy and high specific resistance located in the cell, which contain media of this type, and to the use of these media for electro-optical purposes.

The liquid-crystal mixtures according to the invention enable a significant broadening of the available parameter latitude. The achievable combinations of clearing point, viscosity at low temperature, thermal and UV stability and high optical anisotropy are far superior to previous materials from the prior art.

The mixtures according to the invention are particularly suitable for mobile applications and TFT applications, such as, for example, mobile telephones and PDAs. Furthermore, the mixtures according to the invention can be used in FFS, HB-FFS, VA-IPS, OCB and IPS displays.

The liquid-crystal mixtures according to the invention, while retaining the nematic phase down to −20° C. and preferably down to −30° C., particularly preferably down to −40° C., and the clearing point ≥75° C., preferably ≥80° C., at the same time allow rotational viscosities γ₁ of ≤110 mPa·s, particularly preferably ≤100 mPa·s, to be achieved, enabling excellent MLC displays having fast response times to be achieved. The rotational viscosities are determined at 20° C.

The dielectric anisotropy Δε of the liquid-crystal mixtures according to the invention at 20° C. is preferably ≥+7, particularly preferably ≥+8, especially preferably ≥10. In addition, the mixtures are characterised by low operating voltages. The threshold voltage of the liquid-crystal mixtures according to the invention is preferably ≤2.0 V. The birefringence Δn of the liquid-crystal mixtures according to the invention at 20° C. is preferably ≥0.09, particularly preferably ≥0.10.

The nematic phase range of the liquid-crystal mixtures according to the invention preferably has a width of at least 90°, in particular at least 100°. This range preferably extends at least from −25° to +70° C.

It goes without saying that, through a suitable choice of the components of the mixtures according to the invention, it is also possible for higher clearing points (for example above 100° C.) to be achieved at higher threshold voltages or lower clearing points to be achieved at lower threshold voltages with retention of the other advantageous properties. At viscosities correspondingly increased only slightly, it is likewise possible to obtain mixtures having a higher Δε and thus low thresholds. The MLC displays according to the invention preferably operate at the first Gooch and Tarry transmission minimum [C. H. Gooch and H. A. Tarry, Electron. Lett. 10, 2-4, 1974; C. H. Gooch and H. A. Tarry, Appl. Phys., Vol. 8, 1575-1584, 1975], where, besides particularly favourable electro-optical properties, such as, for example, high steepness of the characteristic line and low angle dependence of the contrast (German patent 30 22 818), lower dielectric anisotropy is sufficient at the same threshold voltage as in an analogous display at the second minimum. This enables significantly higher specific resistance values to be achieved using the mixtures according to the invention at the first minimum than in the case of mixtures comprising cyano compounds. Through a suitable choice of the individual components and their proportions by weight, the person skilled in the art is able to set the birefringence necessary for a pre-specified layer thickness of the MLC display using simple routine methods.

Measurements of the voltage holding ratio (HR) [S. Matsumoto et al., Liquid Crystals 5, 1320 (1989); K. Niwa et al., Proc. SID Conference, San Francisco, June 1984, p. 304 (1984); G. Weber et al., Liquid Crystals 5, 1381 (1989)] have shown that mixtures according to the invention comprising one or more compounds of the formula IA exhibit a significantly smaller decrease in the HR on UV exposure than analogous mixtures comprising cyanophenylcyclohexanes of the formula

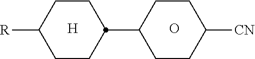

or esters of the formula

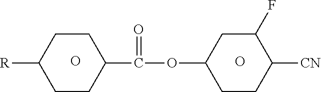

instead of one or more compounds of the formula IA.

The light stability and UV stability of the mixtures according to the invention are considerably better, i.e. they exhibit a significantly smaller decrease in the HR on exposure to light or UV.

The construction of the MLC display according to the invention from polarisers, electrode base plates and surface-treated electrodes corresponds to the usual design for displays of this type. The term usual design is broadly drawn here and also encompasses all derivatives and modifications of the MLC display, in particular including matrix display elements based on poly-Si TFTs or MIM.

A significant difference between the displays according to the invention and the hitherto conventional displays based on the twisted nematic cell consists, however, in the choice of the liquid-crystal parameters of the liquid-crystal layer.

The liquid-crystal mixtures which can be used in accordance with the invention are prepared in a manner conventional per se, for example by mixing one or more compounds of the formulae 1-5 with one or more compounds of the formulae II-XXX or with further liquid-crystalline compounds and/or additives. In general, the desired amount of the components used in lesser amount is dissolved in the components making up the principal constituent, advantageously at elevated temperature. It is also possible to mix solutions of the components in an organic solvent, for example in acetone, chloroform or methanol, and to remove the solvent again, for example by distillation, after thorough mixing.

The dielectrics may also comprise further additives known to the person skilled in the art and described in the literature, such as, for example, UV stabilisers, such as Tinuvin®, e.g. Tinuvin® 770, from Ciba Chemicals, antioxidants, e.g. TEMPOL, microparticles, free-radical scavengers, nanopartides, etc. For example, 0-15% of pleochroic dyes or chiral dopants can be added. Suitable stabilisers and dopants are mentioned below in Tables B and C.

Polymerisable compounds, so-called reactive mesogens (RMs), for example as disclosed in U.S. Pat. No. 6,861,107, may furthermore be added to the mixtures according to the invention in concentrations of preferably 0.12-5% by weight, particularly preferably 0.2-2% by weight, based on the mixture. These mixtures may optionally also comprise an initiator, as described, for example, in U.S. Pat. No. 6,781,665. The initiator, for example Irganox-1076 from Ciba, is preferably added to the mixture comprising polymerisable compounds in amounts of 0-1%. Mixtures of this type can be used for so-called polymer-stabilised (PS) modes, in which polymerisation of the reactive mesogens is intended to take place in the liquid-crystalline mixture, for example for PS-IPS, PS-FFS, PS-TN, PS-VA-IPS. The prerequisite for this is that the liquid-crystal mixture does not itself comprise any polymerisable components.

In a preferred embodiment of the invention, the polymerisable compounds are selected from the compounds of the formula M

R^{Ma}-A^{M1}-(Z^{M1}-A^{M2})ₘ₁-R^{Mb} M

in which the individual radicals have the following meanings:
R^{Ma} and R^{Mb} each, independently of one another, denote P, P-Sp-, H, halogen, SF₅, NO₂, an alkyl, alkenyl or alkynyl group, where at least one of the radicals R^{Ma} and R^{Mb} preferably denotes or contains a group P or P-Sp-,
P denotes a polymerisable group,
Sp denotes a spacer group or a single bond,
A^{M1} and A^{M2} each, independently of one another, denote an aromatic, heteroaromatic, alicyclic or heterocyclic group, preferably having 4 to 25 ring atoms, preferably C atoms, which may also encompass or contain fused rings, and which may optionally be mono- or polysubstituted by L,
L denotes P, P-Sp-, OH, CH₂OH, F, Cl, Br, I, —CN, —NO₂, —NCO, —NCS, —OCN, —SCN, —C(═O)N(R^{x})₂, —C(═O)Y¹, —C(═O)R^{x}, —N(R^{x})₂, optionally substituted silyl, optionally substituted aryl having 6 to 20 C atoms, or straight-chain or branched alkyl, alkoxy, alkylcarbonyl, alkoxycarbonyl, alkylcarbonyloxy or alkoxycarbonyloxy having 1 to 25 C atoms, in which, in addition, one or more H atoms may be replaced by F, Cl, P or P-Sp-, preferably P, P-Sp-, H, OH, CH₂OH, halogen, SF₅, NO₂, an alkyl, alkenyl or alkynyl group,
Y¹ denotes halogen,
Z^{M1} denotes —O—, —S—, —CO—, —CO—O—, —OCO—, —O—CO—O—, —OCH₂—, —CH₂O—, —SCH₂—, —CH₂S—, —CF₂O—, —OCF₂—, —CF₂S—, —SCF₂—, —(CH₂)ₙ₁—, —CF₂CH₂—, —CH₂CF₂—, —(CF₂)ₙ₁—, —CH═CH—, —CF═CF—, —C≡C—, —CH═CH—, —COO—, —OCO—CH═CH—, CR⁰R⁰⁰ or a single bond,
R⁰ and R⁰⁰ each, independently of one another, denote H or alkyl having 1 to 12 C atoms,
R^{x} denotes P, P-Sp-, H, halogen, straight-chain, branched or cyclic alkyl having 1 to 25 C atoms, in which, in addition, one or more non-adjacent CH₂ groups may be replaced by —O—, —S—, —CO—, —CO—O—, —O—CO—, —O—CO—O— in such a way that O and/or S atoms are not linked directly to one another, and in which, in addition, one or more H atoms may be replaced by F, Cl, P or P-Sp-, an optionally substituted aryl or aryloxy group having 6 to 40 C atoms, or an optionally substituted heteroaryl or heteroaryloxy group having 2 to 40 C atoms,
m1 denotes 0, 1, 2, 3 or 4, and
n1 denotes 1, 2, 3 or 4,
   where at least one, preferably one, two or three, particularly preferably one or two, from the group R^{Ma}, R^{Mb} and the substituents L present denotes a group P or P-Sp- or contains at least one group P or P-Sp-.

Particularly preferred compounds of the formula M are those in which
R^{Ma} and R^{Mb} each, independently of one another, denote P, P-Sp-, H, F, Cl, Br, I, —CN, —NO₂, —NCO, —NCS, —OCN, —SCN, SF₅ or straight-chain or branched alkyl having 1 to 25 C atoms, in which, in addition, one or more non-adjacent CH₂ groups may each be replaced, independently of one another, by —C(R⁰)═C(R⁰⁰)—, —C≡C−, —N(R⁰⁰)—, —O—, —S—, —CO—, —CO—O—, —O—CO—, —O—CO—O— in such a way that O and/or S atoms are not linked directly to one another, and in which, in addition, one or more H atoms may be replaced by F, Cl, Br, I, CN, P or P-Sp-, where at least one of the radicals R^{Ma} and R^{Mb} preferably denotes or contains a group P or P-Sp-,
A^{M1} and A^{M2} each, independently of one another, denote 1,4-phenylene, naphthalene-1,4-diyl, naphthalene-2,6-diyl, phenanthrene-2,7-diyl, anthracene-2,7-diyl, fluorene-2,7-diyl, coumarin, flavone, where, in addition, one or more CH groups in these groups may be replaced by N, cyclohexane-1,4-diyl, in which, in addition, one or more non-adjacent CH₂ groups may be replaced by O and/or S, 1,4-cyclohexenylene, bicyclo[1.1.1]pentane-1,3-diyl, bicyclo[2.2.2]octane-1,4-diyl, spiro[3.3]heptane-2,6-diyl, piperidine-1,4-diyl, decahydronaphthalene-2,6-diyl, 1,2,3,4-tetrahydronaphthalene-2,6-diyl, indane-2,5-diyl or octahydro-4,7-methanoindane-2,5-diyl, where all these groups may be unsubstituted or mono- or polysubstituted by L,
L denotes P, P-Sp-, OH, CH₂OH, F, Cl, Br, I, —CN, —NO₂, —NCO, —NCS, —OCN, —SCN, —C(═O)N(R^{x})₂, —C(═O)Y¹, —C(═O)R^{x}, —N(R^{x})₂, optionally substituted silyl, optionally substituted aryl having 6 to 20 C atoms, or straight-chain or branched alkyl, alkoxy, alkylcarbonyl, alkoxycarbonyl, alkylcarbonyloxy or alkoxycarbonyloxy having 1 to 25 C atoms, in which, in addition, one or more H atoms may be replaced by F, Cl, P or P-Sp-,
P denotes a polymerisable group,
Y¹ denotes halogen,
R^{x} denotes P, P-Sp-, H, halogen, straight-chain, branched or cyclic alkyl having 1 to 25 C atoms, in which, in addition, one or more non-adjacent CH₂ groups may be replaced by —O—, —S—, —CO—, —CO—O—, —O—CO—, —O—CO—O— in such a way that O and/or S atoms are not linked directly to one another, and in which, in addition, one or more H atoms may be replaced by F, Cl, P or P-Sp-, an optionally substituted aryl or aryloxy group having 6 to 40 C atoms, or an optionally substituted heteroaryl or heteroaryloxy group having 2 to 40 C atoms.

Very particular preference is given to compounds of the formula M in which one of R^{Ma} and R^{Mb} or both denote(s) P or P-Sp-.

Suitable and preferred RMs for use in liquid-crystalline media and PS mode displays according to the invention are selected, for example, from the following formulae:

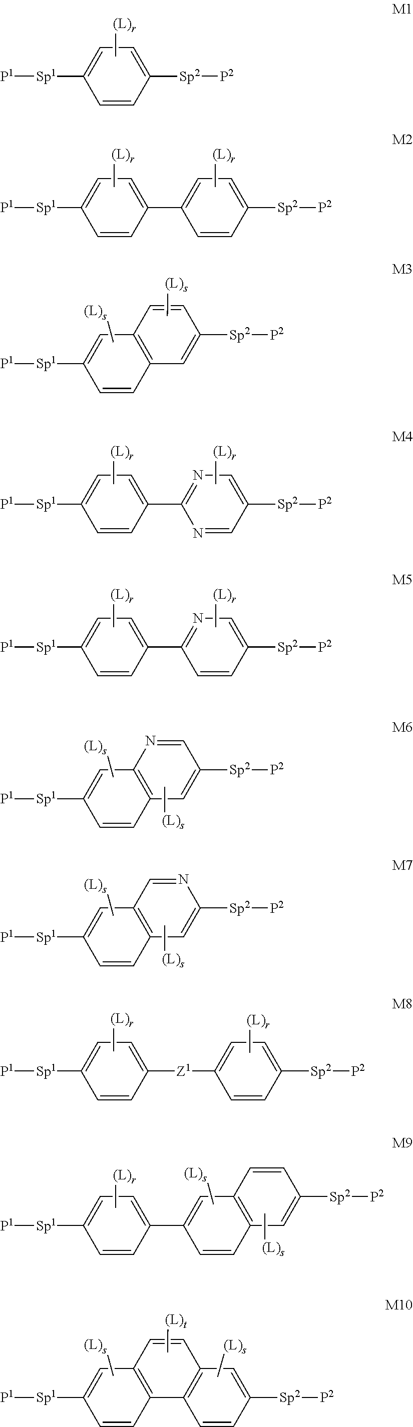

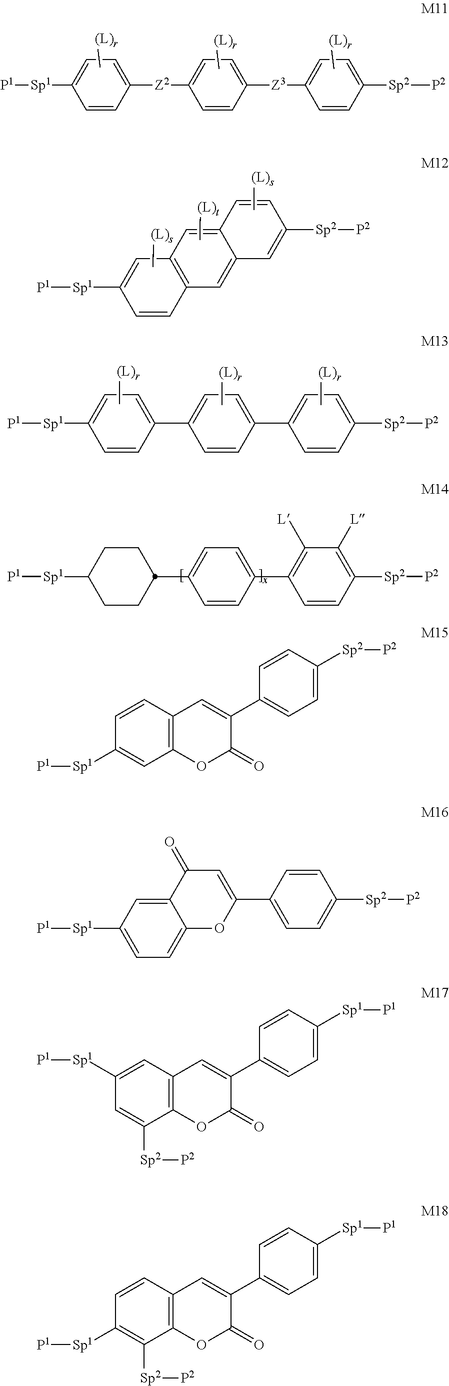

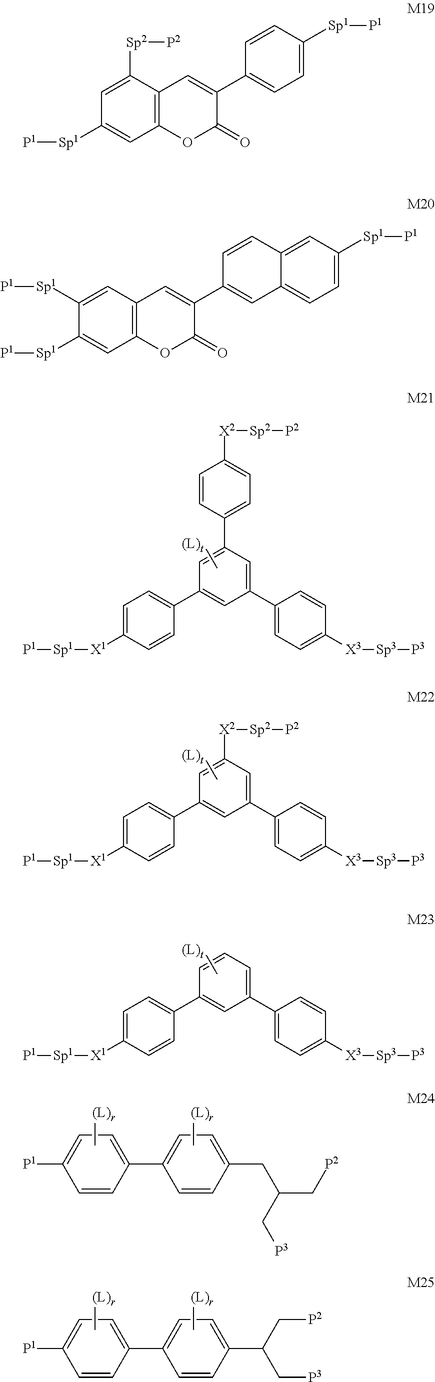

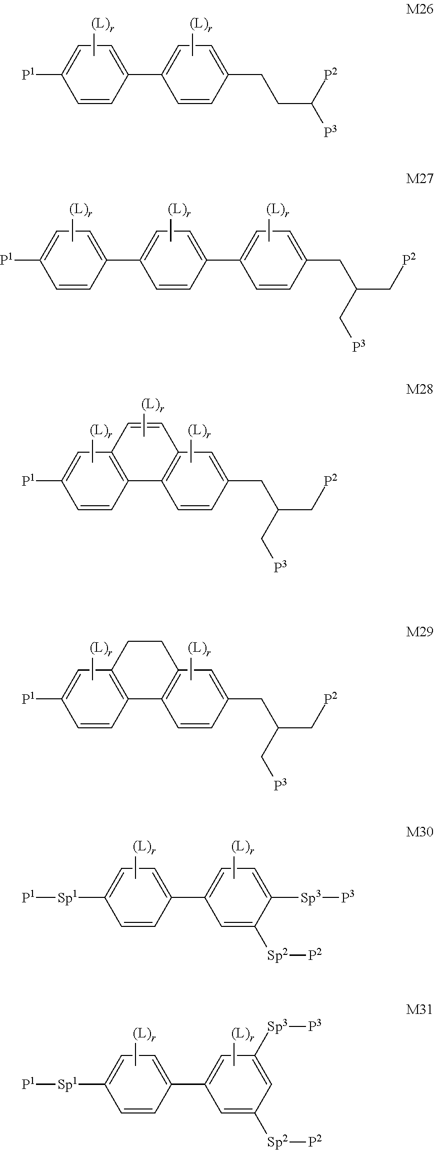

in which the individual radicals have the following meanings:
P¹⁻³ each, independently of one another, denote a polymerisable group, preferably having one of the meanings indicated above and below for P, particularly preferably an acrylate, methacrylate, fluoroacrylate, oxetane, vinyloxy or epoxy group,
Sp¹⁻³ each, independently of one another, denote a single bond or a spacer group, preferably having one of the meanings indicated above and below for Sp, and particularly preferably —(CH₂)ₚ₁—, —(CH₂)ₚ₁—O—, —(CH₂)ₚ₁—CO—O— or —(CH₂)ₚ₁—O—CO—O—, in which p1 is an integer from 1 to 12, and where the linking of the last-mentioned groups to the adjacent ring takes place via the O atom, where one of the radicals P¹-Sp¹-, P²—Sp²- and P³—Sp³- may also denote R^{aa},
R^{aa} denotes H, F, Cl, CN or straight-chain or branched alkyl having 1 to 25 C atoms, in which, in addition, one or more non-adjacent CH₂ groups may each be replaced, independently of one another, by —C(R⁰)═C(R⁰⁰)—, —C≡C—, —N(R⁰)—, —O—, —S—, —CO—, —CO—O—, —O—CO—, —O—CO—O— in such a way that O and/or S atoms are not linked directly to one another, and in which, in addition, one or more H atoms may be replaced by F, Cl, CN or P¹—Sp¹-, particularly preferably straight-chain or branched, optionally mono- or polyfluorinated alkyl, alkoxy, alkenyl, alkynyl, alkylcarbonyl, alkoxycarbonyl or alkylcarbonyloxy having 1 to 12 C atoms (where the alkenyl and alkynyl radicals have at least two C atoms and the branched radicals have at least three C atoms),
R⁰, R⁰⁰ each, independently of one another and on each occurrence identically or differently, denote H or alkyl having 1 to 12 C atoms,
R^{y} and R^{z} each, independently of one another, denote H, F, CH₃ or CF₃,
Z¹ denotes —O—, —CO—, —C(R^{y}R^{z})— or —CF₂CF₂—,
Z² and Z³ each, independently of one another, denote —CO—O—, —O—CO—, —CH₂O—, —OCH₂—, —CF₂O—, —OCF₂— or —(CH₂)ₙ—, where n is 2, 3 or 4,
L on each occurrence, identically or differently, denotes F, Cl, CN, or straight-chain or branched, optionally mono- or polyfluorinated alkyl, alkoxy, alkenyl, alkynyl, alkylcarbonyl, alkoxycarbonyl or alkylcarbonyloxy having 1 to 12 C atoms, preferably F,
L′ and L″ each, independently of one another, denote H, F or Cl,
r denotes 0, 1, 2, 3 or 4,
s denotes 0, 1, 2 or 3,
t denotes 0, 1 or 2, and
x denotes 0 or 1.

Suitable polymerisable compounds are listed, for example, in Table D.

The liquid-crystalline media in accordance with the present application preferably comprise in total 0.01 to 3%, preferably 0.1 to 1.0%, particularly preferably 0.1 to 0.5%, of polymerisable compounds.

Particular preference is given to the polymerisable compounds of the formulae M2, M13, M17, M22, M23, M24 and M30.

Preference is furthermore given to the polymerisable compounds of the formulae M15 to M31, in particular M17, M18, M19, M22, M23, M24, M25, M26, M30 and M31.

The present invention thus also relates to the use of the mixtures according to the invention in electro-optical displays and to the use of the mixtures according to the invention in shutter spectacles, in particular for 3D applications, and in TN, PS-TN, STN, TN-TFT, OCB, IPS, PS-IPS, FFS, HB-FFS, PS-FFS and PS-VA-IPS displays.

Throughout the patent application and in the working examples, the structures of the liquid-crystal compounds are indicated by means of acronyms. Unless indicated otherwise, the transformation into chemical formulae takes place in accordance with Tables 1-3. All radicals CₙH₂ₙ₊₁ and CₘH₂ₘ₊₁ or CₙH₂ₙ and CₘH₂ₘ are straight-chain alkyl radicals or alkylene radicals having n and m C atoms each. n, m and k each, independently of one another, denote 0, 1, 2, 3, 4, 5, 6, 7, 8, 9, 10, 11 or 12, preferably 0, 1, 2, 3, 4, 5 or 6. In Table 1 the ring elements of the respective compound are coded, in Table 2 the bridging elements are listed and in Table 3 the meanings of the symbols for the left-hand or right-hand side chains of the compounds are indicated.

TABLE 1
Ring elements

| | |
|---|---|
| 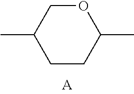 | 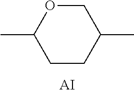 |
| 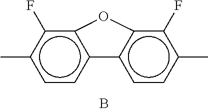 | 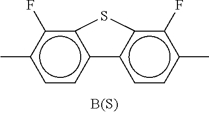 |
| 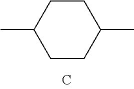 | |
| 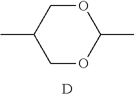 | 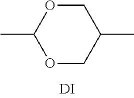 |
| 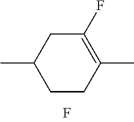 | 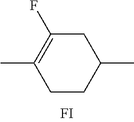 |
| 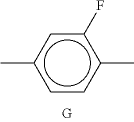 | 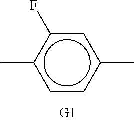 |
| 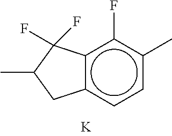 | |
| 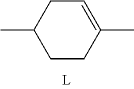 | 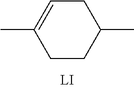 |
| 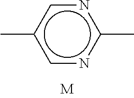 | 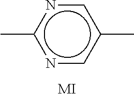 |
| 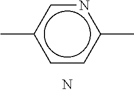 | 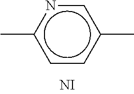 |
| 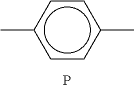 | |
| 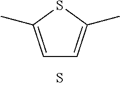 | |
| 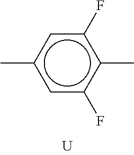 | 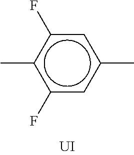 |
| 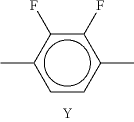 | |
| 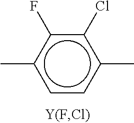 | 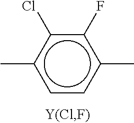 |

TABLE 2
Bridging elements

| | | | |
|---|---|---|---|
| E | —CH₂CH₂— | | |
| V | —CH═CH— | | |
| T | —C≡C— | | |
| W | —CF₂CF₂— | | |
| Z | —COO— | ZI | —OCO— |
| O | —CH₂O— | OI | —OCH₂— |
| Q | —CF₂O— | QI | —OCF₂— |

TABLE 3
Side chains

| Left-hand side chain | | Right-hand side chain | |
|---|---|---|---|
| n- | CₙH₂ₙ₊₁— | -n | —CₙH₂ₙ₊₁ |
| nO- | CₙH₂ₙ₊₁—O— | -On | —O—CₙH₂ₙ₊₁ |
| V- | CH₂═CH— | -V | —CH═CH₂ |
| nV- | CₙH₂ₙ₊₁—CH═CH— | -nV | —CₙH₂ₙ—CH═CH₂ |
| Vn- | CH₂═CH—CₙH₂ₙ— | -Vn | —CH═CH-CₙH₂ₙ₊₁ |
| nVm- | CH₂ₙ₊₁—CH═CH—CₘH₂ₘ— | -nVm | —CₙH₂ₙ—CH═CH—CₘH₂ₘ₊₁ |
| N- | N≡C— | -N | —C≡N |
| F- | F— | -F | —F |
| Cl- | Cl— | -Cl | —Cl |
| M- | CFH₂— | -M | —CFH₂ |
| D- | CF₂H— | -D | —CF₂H |
| T- | CF₃— | -T | —CF₃ |
| MO- | CFH₂O— | -OM | —OCFH₂ |
| DO- | CF₂HO— | -OD | —OCF₂H |
| TO- | CF₃O— | -OT | —OCF₃ |
| T- | CF₃— | -T | —CF₃ |
| A- | H—C≡C— | -A | —C≡C—H |
| C5- | 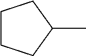 | -C5 | 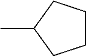 |

Preferred mixture components are found in Table A.

Besides one or more compounds of the formulae 1 to 5, the mixtures according to the invention preferably comprise at least one compound selected from the compounds shown below in Table A.

TABLE A
In following formulae, k, n and m each, independently of one another, denote
0, 1, 2, 3, 4, 5, 6, 7, 8, 9, 10, 11 or 12, in particular 2, 3 or 5, furthermore 0, 4 or 6.

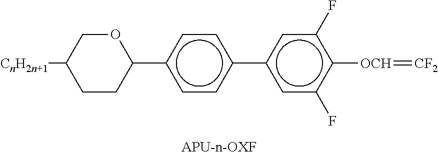

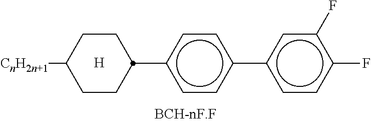

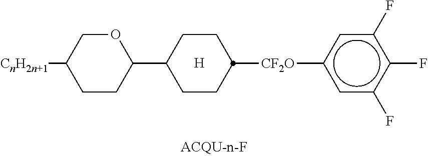

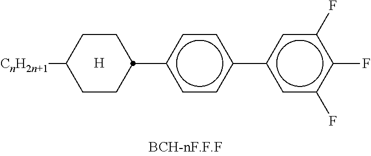

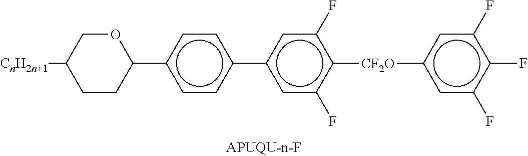

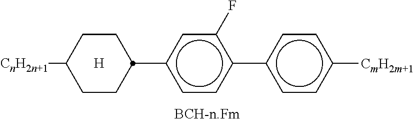

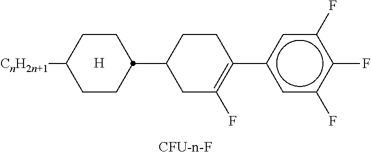

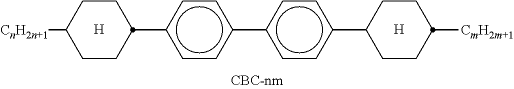

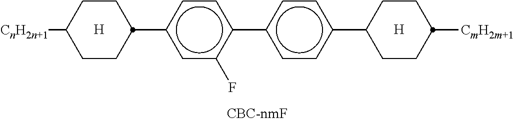

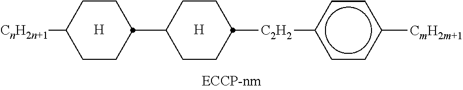

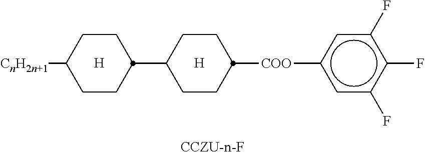

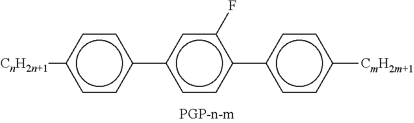

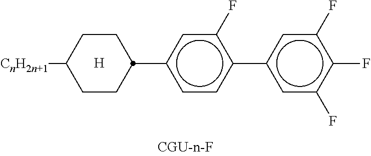

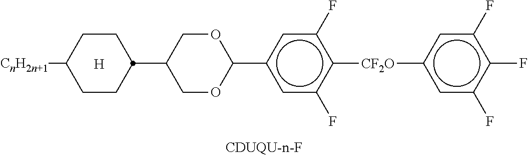

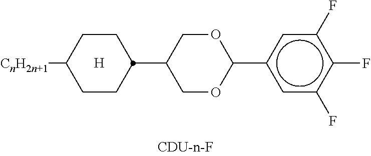

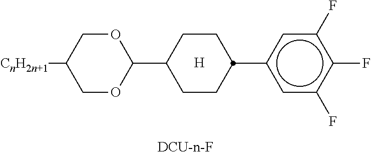

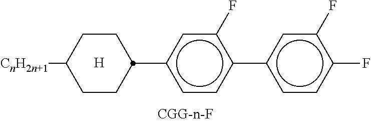

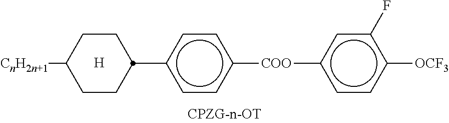

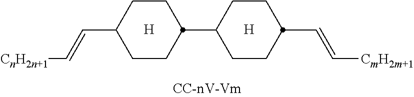

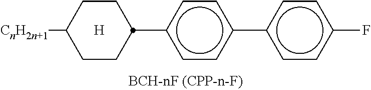

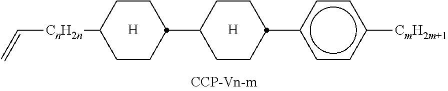

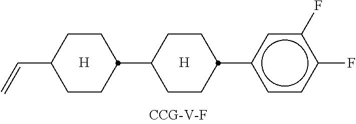

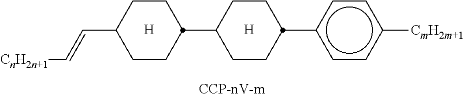

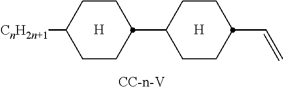

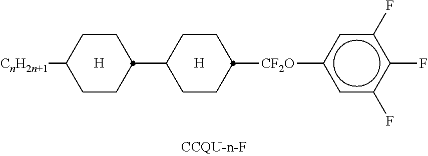

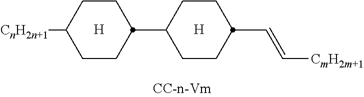

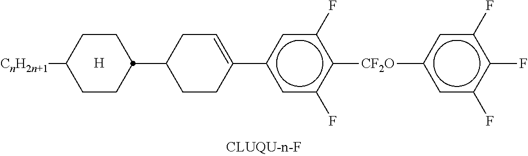

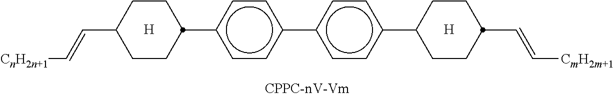

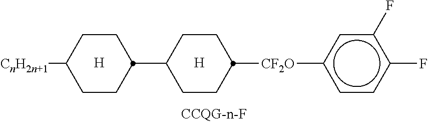

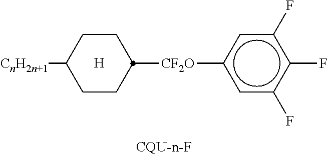

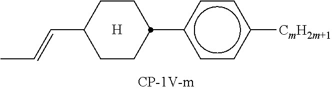

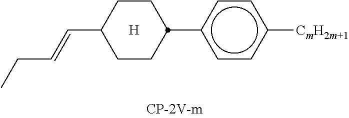

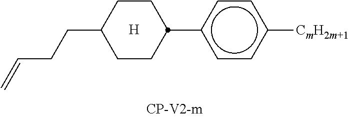

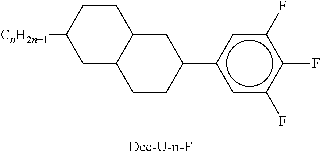

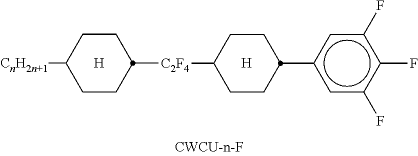

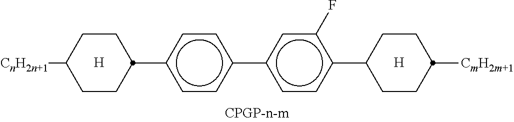

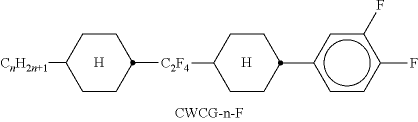

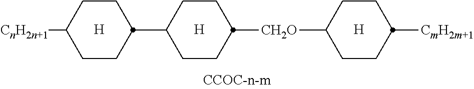

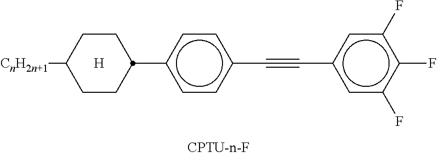

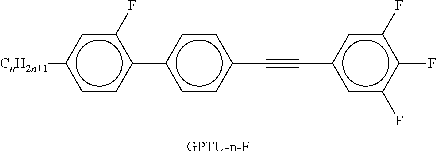

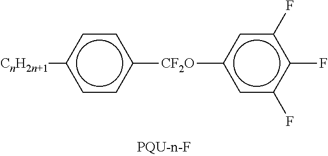

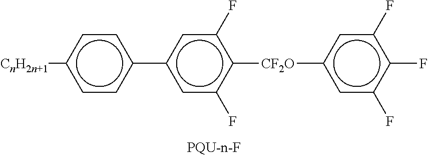

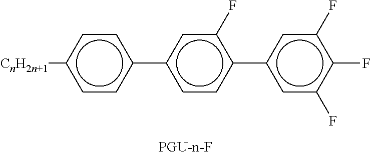

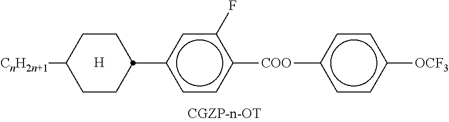

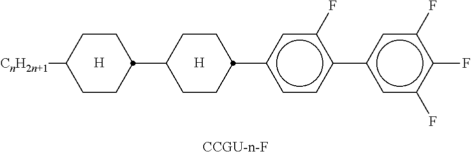

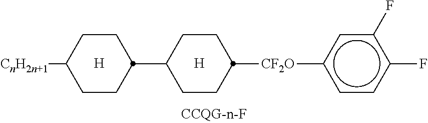

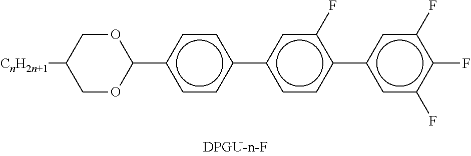

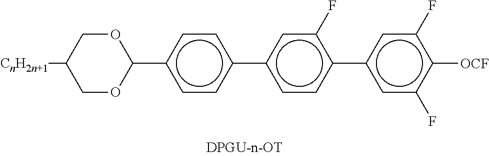

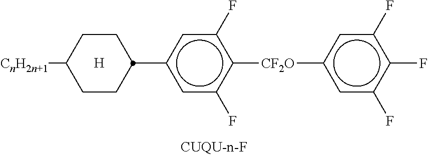

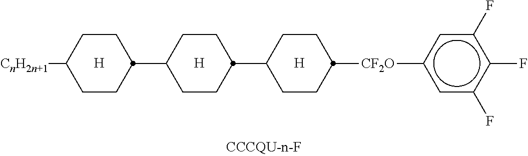

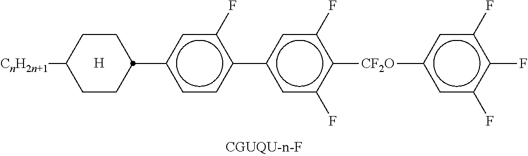

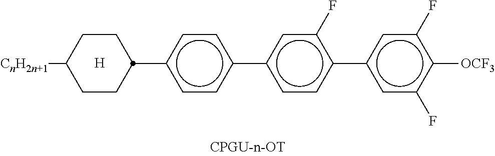

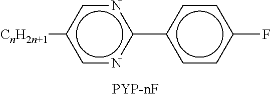

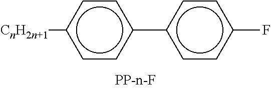

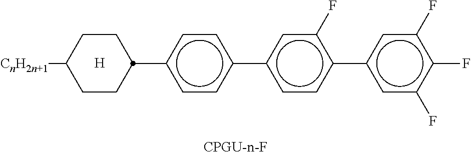

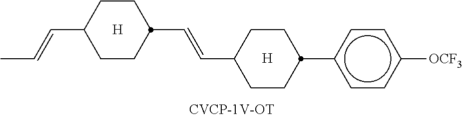

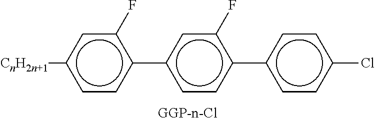

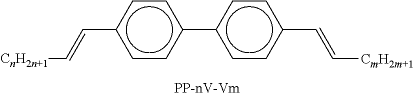

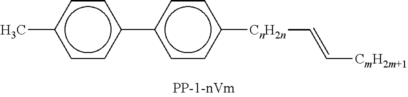

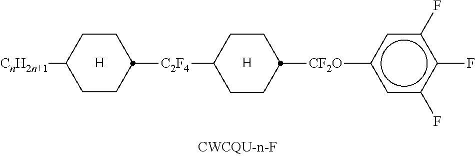

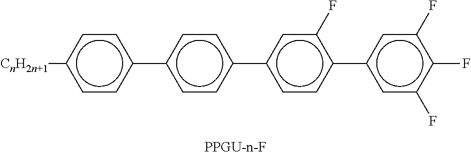

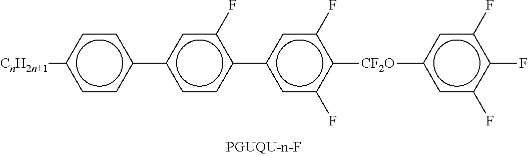

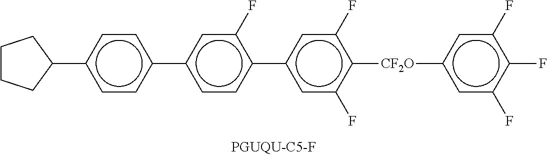

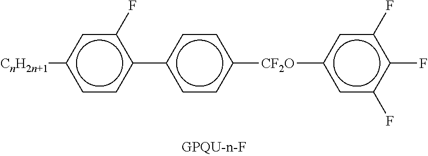

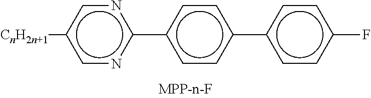

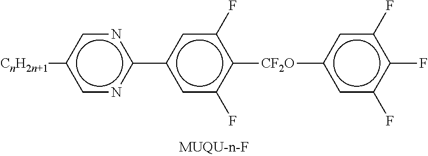

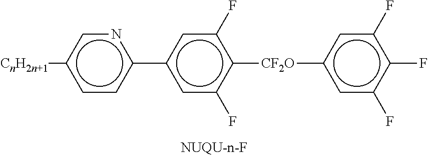

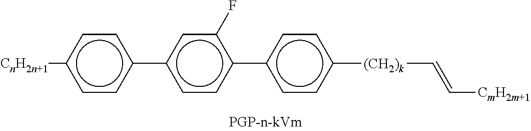

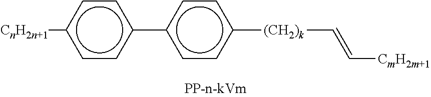

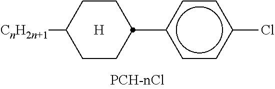

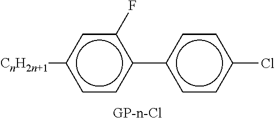

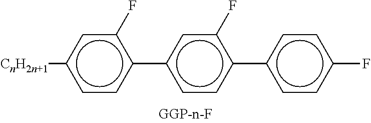

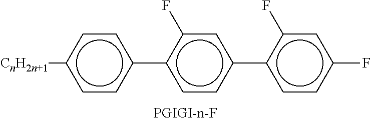

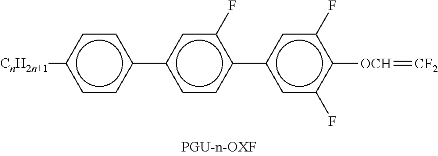

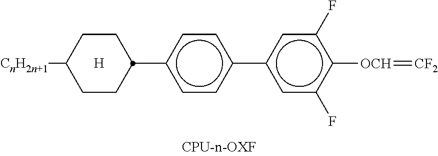

(O)CₘH₂ₘ₊₁ means OCₘH₂ₘ₊₁ or CₘH₂ₘ₊₁.

Particular preference is given to liquid-crystalline mixtures which, besides the compounds of the formulae 1 to 5, comprise at least one, two, three, four or more compounds from Table A.

TABLE B
Table B indicates possible dopants which are generally added to the mixtures according to the invention.
The mixtures preferably comprise 0-10% by weight, in particular 0.01-5% by weight and particularly
preferably 0.01-3% by weight of dopants.

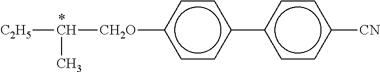

C 15

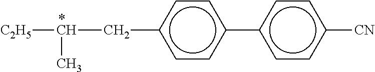

CB 15

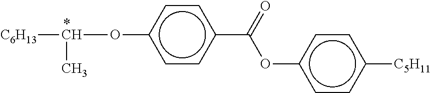

CM 21

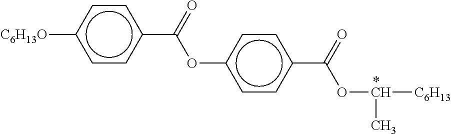

R/S-811

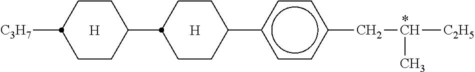

CM 44

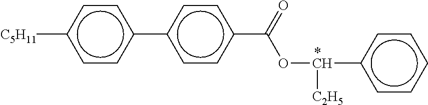

CM 45

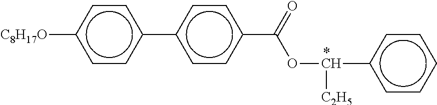

CM 47

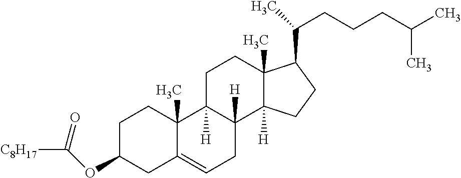

CN

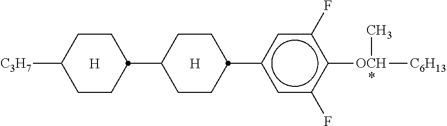

R/S-2011

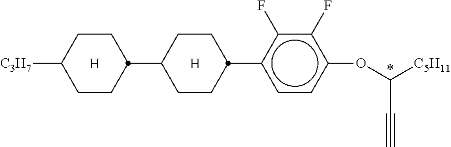

R/S-3011

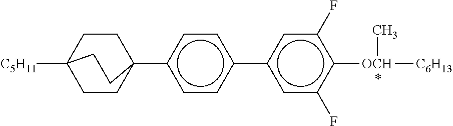

R/S-4011

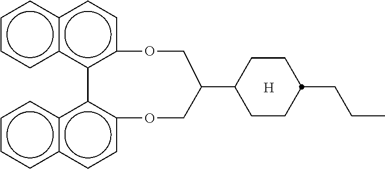

R/S-5011

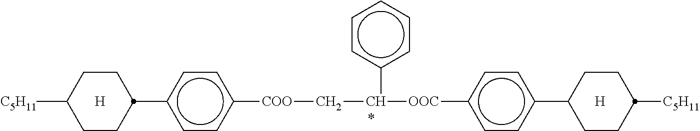

R/S-1011

TABLE C
Stabilisers, which can be added, for example, to the mixtures according to
the invention in amounts of 0-10% by weight, are mentioned below.

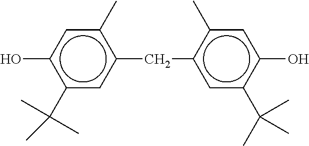

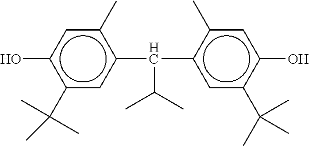

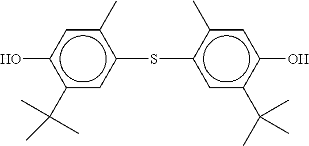

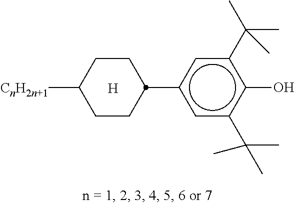

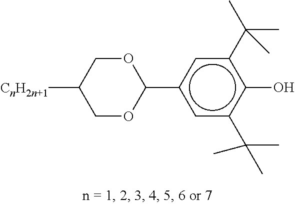

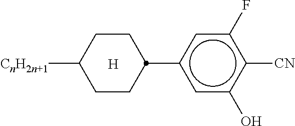

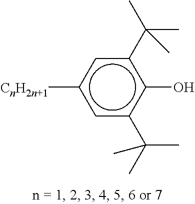

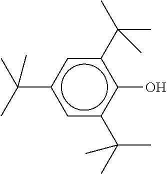

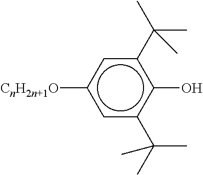

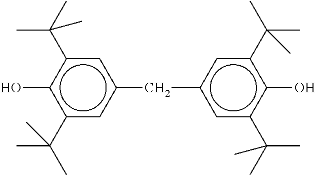

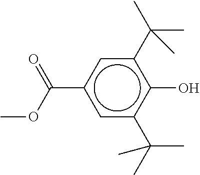

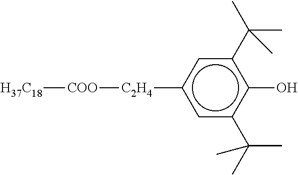

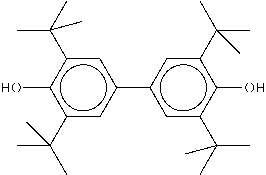

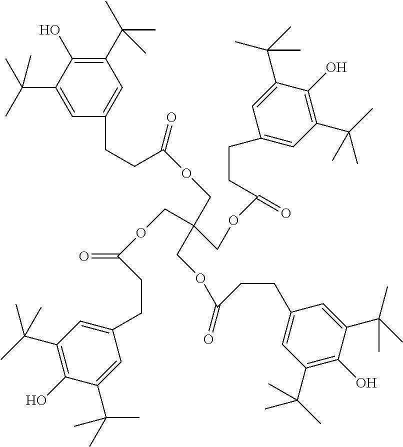 [SMILES: CC(C)(C)c1cc(CCC(=O)OCC(COC(=O)CCc2cc(C(C)(C)C)c(O)c(C(C)(C)C)c2)(COC(=O)CCc2cc(C(C)(C)C)c(O)c(C(C)(C)C)c2)COC(=O)CCc2cc(C(C)(C)C)c(O)c(C(C)(C)C)c2)cc(C(C)(C)C)c1O]

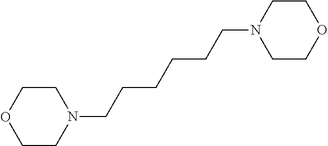 [SMILES: C(CCCN1CCOCC1)CCN1CCOCC1]

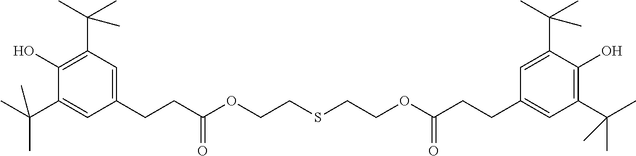 [SMILES: CC(C)(C)c1cc(CCC(=O)OCCSCCOC(=O)CCc2cc(C(C)(C)C)c(O)c(C(C)(C)C)c2)cc(C(C)(C)C)c1O]

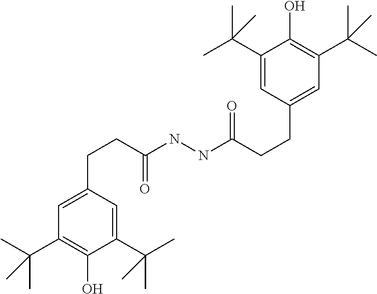 [SMILES: CC(C)(C)c1cc(CCC(=O)NNC(=O)CCc2cc(C(C)(C)C)c(O)c(C(C)(C)C)c2)cc(C(C)(C)C)c1O]

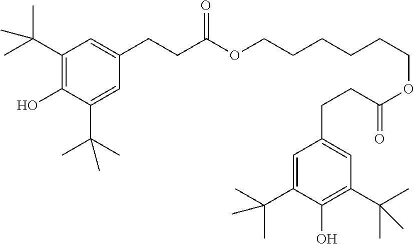 [SMILES: CC(C)(C)c1cc(CCC(=O)OCCCCCCOC(=O)CCc2cc(C(C)(C)C)c(O)c(C(C)(C)C)c2)cc(C(C)(C)C)c1O]

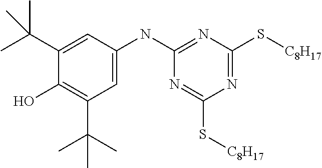

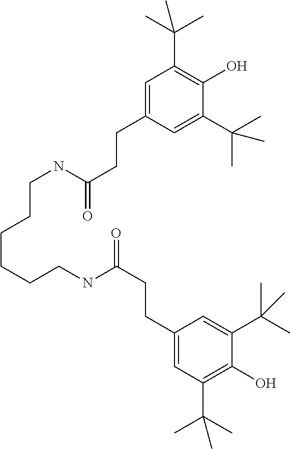 [SMILES: CC(C)(C)c1cc(CCC(=O)NCCCCCCNC(=O)CCc2cc(C(C)(C)C)c(O)c(C(C)(C)C)c2)cc(C(C)(C)C)c1O]

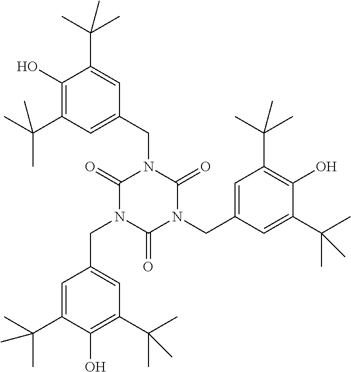 [SMILES: CC(C)(C)c1cc(Cn2c(=O)n(Cc3cc(C(C)(C)C)c(O)c(C(C)(C)C)c3)c(=O)n(Cc3cc(C(C)(C)C)c(O)c(C(C)(C)C)c3)c2=O)cc(C(C)(C)C)c1O]

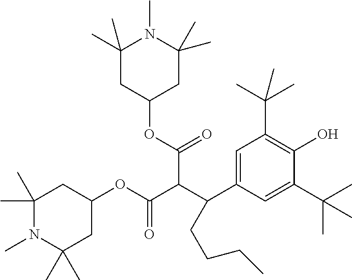 [SMILES: CCCCC(c1cc(C(C)(C)C)c(O)c(C(C)(C)C)c1)C(C(=O)OC1CC(C)(C)N(C)C(C)(C)C1)C(=O)OC1CC(C)(C)N(C)C(C)(C)C1]

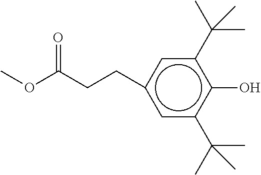

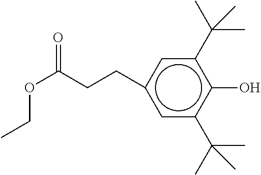

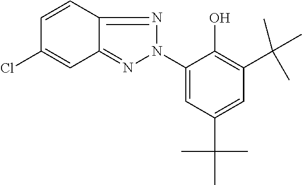 [SMILES: CC(C)(C)c1cc(-n2nc3ccc(Cl)cc3n2)c(O)c(C(C)(C)C)c1]

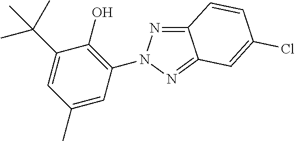 [SMILES: Cc1cc(-n2nc3ccc(Cl)cc3n2)c(O)c(C(C)(C)C)c1]

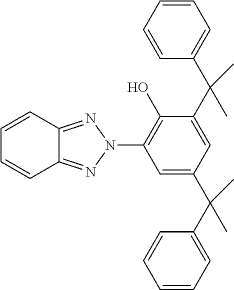 [SMILES: CC(C)(c1ccccc1)c1cc(-n2nc3ccccc3n2)c(O)c(C(C)(C)c2ccccc2)c1]

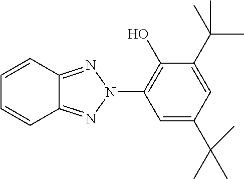 [SMILES: CC(C)(C)c1cc(-n2nc3ccccc3n2)c(O)c(C(C)(C)C)c1]

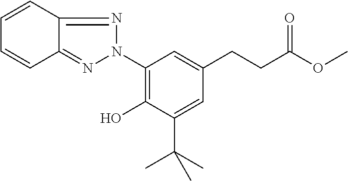 [SMILES: COC(=O)CCc1cc(-n2nc3ccccc3n2)c(O)c(C(C)(C)C)c1]

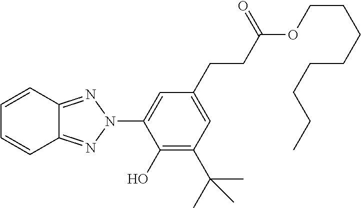 [SMILES: CCCCCCCCOC(=O)CCc1cc(-n2nc3ccccc3n2)c(O)c(C(C)(C)C)c1]

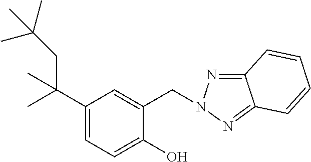 [SMILES: CC(C)(C)CC(C)(C)c1ccc(O)c(Cn2nc3ccccc3n2)c1]

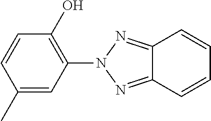 [SMILES: Cc1ccc(O)c(-n2nc3ccccc3n2)c1]

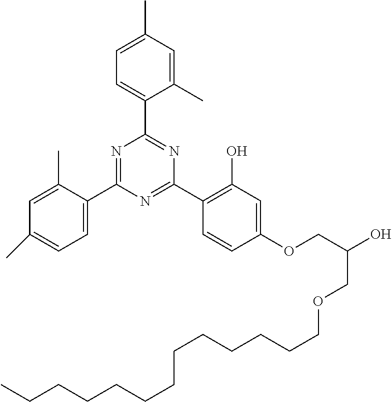 [SMILES: CCCCCCCCCCCCCOCC(O)COc1ccc(-c2nc(-c3ccc(C)cc3C)nc(-c3ccc(C)cc3C)n2)c(O)c1]

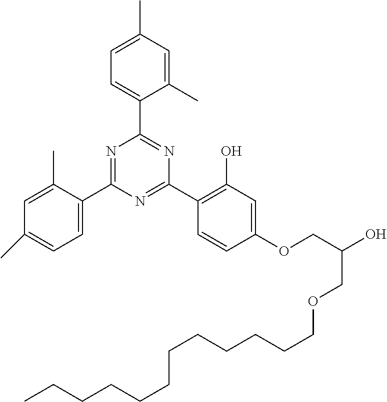 [SMILES: CCCCCCCCCCCCOCC(O)COc1ccc(-c2nc(-c3ccc(C)cc3C)nc(-c3ccc(C)cc3C)n2)c(O)c1]

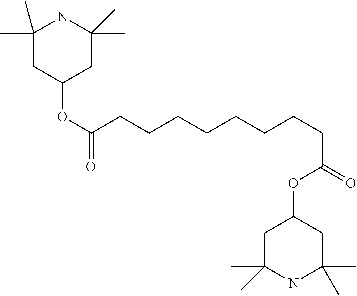

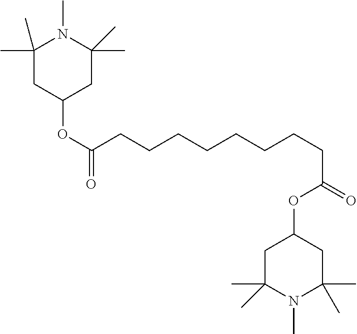

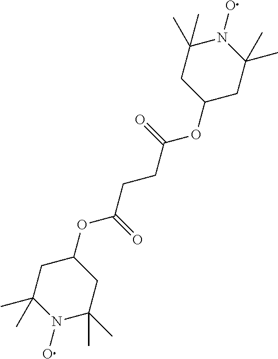

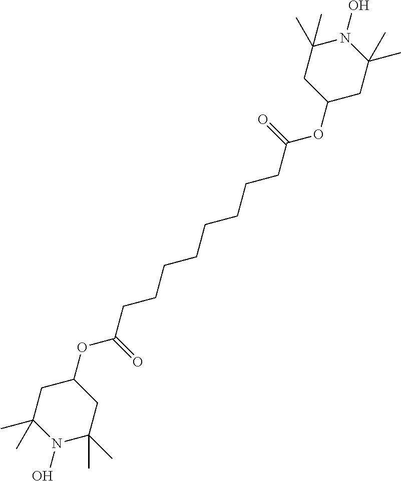

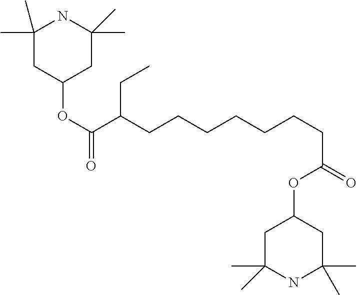

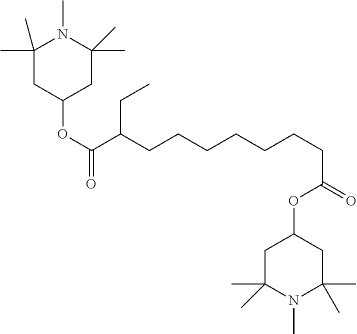

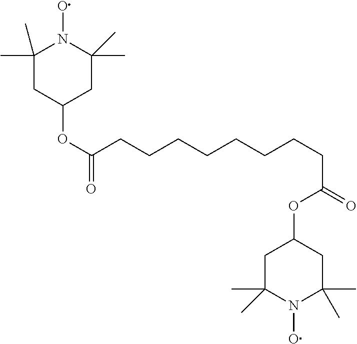

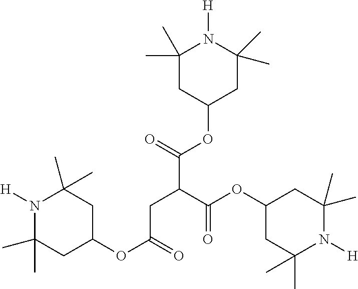

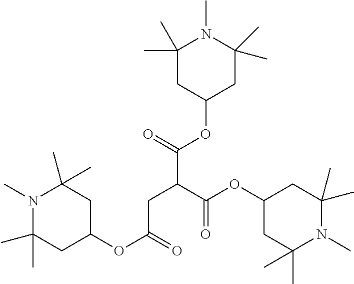

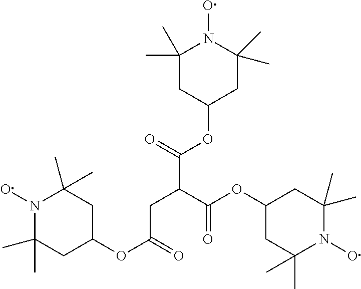

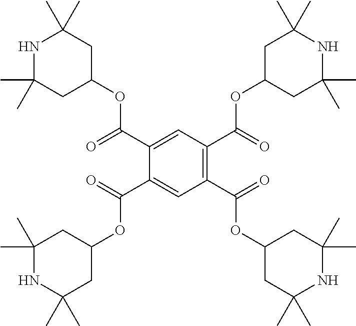

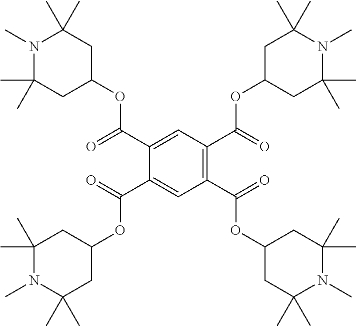

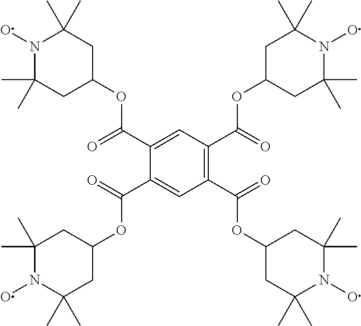

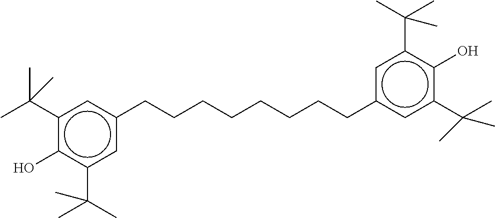

TABLE D
Table D lists example compounds which can preferably be used as reactive mesogenic compounds in the LC media in accordance with the present
invention. If the mixtures according to the invention comprise one or more reactive compounds, they are preferably employed in amounts of
0.01-5% by weight. It may be necessary to add an initiator or a mixture of two or more initiators for the polymerisation. The initiator or initiator
mixture is preferably added in amounts of 0.001-2% by weight, based on the mixture. A suitable initiator is, for example, Irgacure ® 651 (BASF).

| | |
|---|---|
| 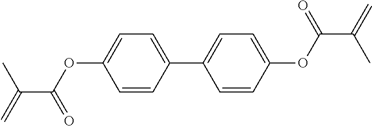 [SMILES: C=C(C)C(=O)Oc1ccc(-c2ccc(OC(=O)C(=C)C)cc2)cc1] | RM-1 |
| 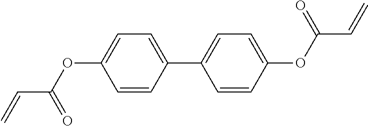 [SMILES: C=CC(=O)Oc1ccc(-c2ccc(OC(=O)C=C)cc2)cc1] | RM-2 |
| 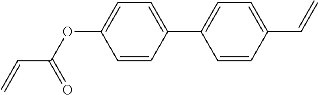 [SMILES: C=CC(=O)Oc1ccc(-c2ccc(C=C)cc2)cc1] | RM-3 |
| 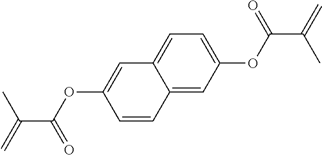 [SMILES: C=C(C)C(=O)Oc1ccc2cc(OC(=O)C(=C)C)ccc2c1] | RM-4 |
| 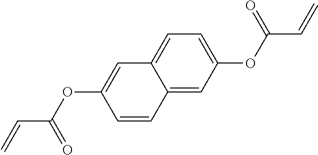 [SMILES: C=CC(=O)Oc1ccc2cc(OC(=O)C=C)ccc2c1] | RM-5 |
| 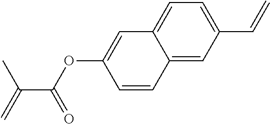 [SMILES: C=Cc1ccc2cc(OC(=O)C(=C)C)ccc2c1] | RM-6 |
| 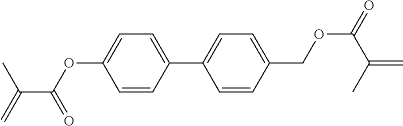 [SMILES: C=C(C)C(=O)OCc1ccc(-c2ccc(OC(=O)C(=C)C)cc2)cc1] | RM-7 |
| 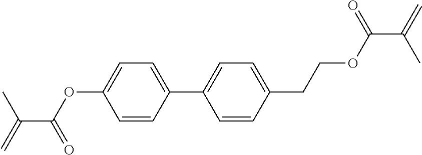 [SMILES: C=C(C)C(=O)OCCc1ccc(-c2ccc(OC(=O)C(=C)C)cc2)cc1] | RM-8 |
| 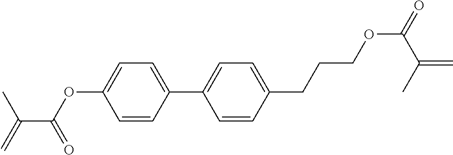 [SMILES: C=C(C)C(=O)OCCCc1ccc(-c2ccc(OC(=O)C(=C)C)cc2)cc1] | RM-9 |
| 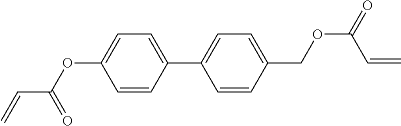 [SMILES: C=CC(=O)OCc1ccc(-c2ccc(OC(=O)C=C)cc2)cc1] | RM-10 |
| 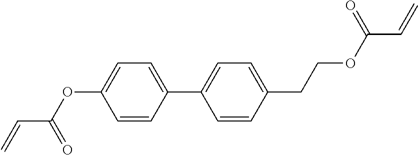 [SMILES: C=CC(=O)OCCc1ccc(-c2ccc(OC(=O)C=C)cc2)cc1] | RM-11 |
| 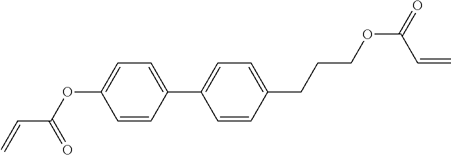 [SMILES: C=CC(=O)OCCCc1ccc(-c2ccc(OC(=O)C=C)cc2)cc1] | RM-12 |
| 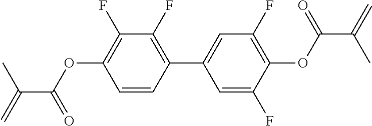 [SMILES: C=C(C)C(=O)Oc1ccc(-c2cc(F)c(OC(=O)C(=C)C)c(F)c2)c(F)c1F] | RM-13 |
| 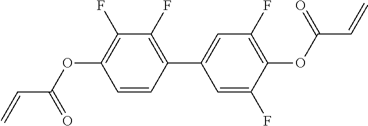 [SMILES: C=CC(=O)Oc1ccc(-c2cc(F)c(OC(=O)C=C)c(F)c2)c(F)c1F] | RM-14 |
| 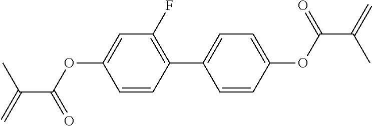 [SMILES: C=C(C)C(=O)Oc1ccc(-c2ccc(OC(=O)C(=C)C)cc2F)cc1] | RM-15 |
| 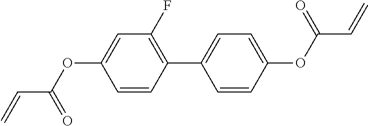 [SMILES: C=CC(=O)Oc1ccc(-c2ccc(OC(=O)C=C)cc2F)cc1] | RM-16 |
| 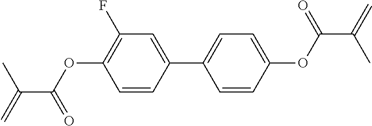 [SMILES: C=C(C)C(=O)Oc1ccc(-c2ccc(OC(=O)C(=C)C)c(F)c2)cc1] | RM-17 |
| 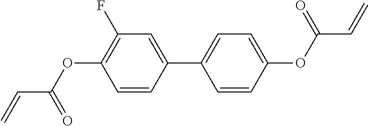 [SMILES: C=CC(=O)Oc1ccc(-c2ccc(OC(=O)C=C)c(F)c2)cc1] | RM-18 |
| 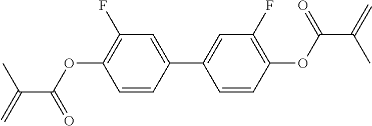 [SMILES: C=C(C)C(=O)Oc1ccc(-c2ccc(OC(=O)C(=C)C)c(F)c2)cc1F] | RM-19 |
| 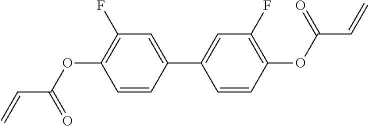 [SMILES: C=CC(=O)Oc1ccc(-c2ccc(OC(=O)C=C)c(F)c2)cc1F] | RM-20 |
| 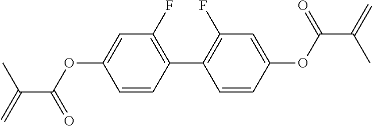 [SMILES: C=C(C)C(=O)Oc1ccc(-c2ccc(OC(=O)C(=C)C)cc2F)c(F)c1] | RM-21 |
| 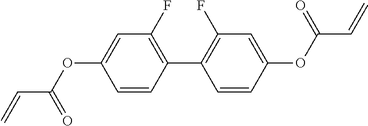 [SMILES: C=CC(=O)Oc1ccc(-c2ccc(OC(=O)C=C)cc2F)c(F)c1] | RM-22 |
| 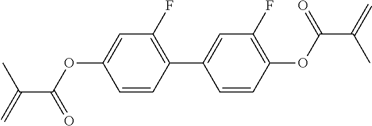 [SMILES: C=C(C)C(=O)Oc1ccc(-c2ccc(OC(=O)C(=C)C)c(F)c2)c(F)c1] | RM-23 |
| 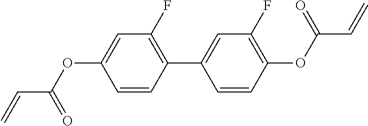 [SMILES: C=CC(=O)Oc1ccc(-c2ccc(OC(=O)C=C)c(F)c2)c(F)c1] | RM-24 |
| 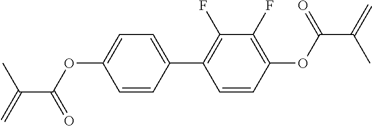 [SMILES: C=C(C)C(=O)Oc1ccc(-c2ccc(OC(=O)C(=C)C)c(F)c2F)cc1] | RM-25 |
| 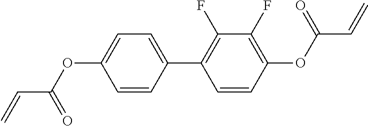 [SMILES: C=CC(=O)Oc1ccc(-c2ccc(OC(=O)C=C)c(F)c2F)cc1] | RM-26 |
| 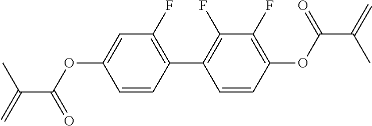 [SMILES: C=C(C)C(=O)Oc1ccc(-c2ccc(OC(=O)C(=C)C)c(F)c2F)c(F)c1] | RM-27 |
| 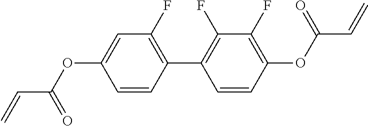 [SMILES: C=CC(=O)Oc1ccc(-c2ccc(OC(=O)C=C)c(F)c2F)c(F)c1] | RM-28 |
| 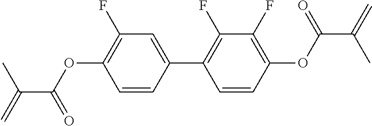 [SMILES: C=C(C)C(=O)Oc1ccc(-c2ccc(OC(=O)C(=C)C)c(F)c2F)cc1F] | RM-29 |
| 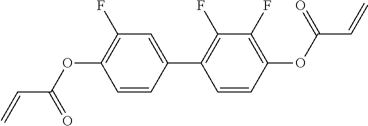 [SMILES: C=CC(=O)Oc1ccc(-c2ccc(OC(=O)C=C)c(F)c2F)cc1F] | RM-30 |
| 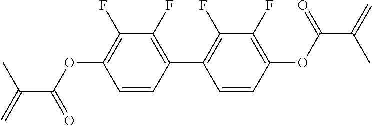 [SMILES: C=C(C)C(=O)Oc1ccc(-c2ccc(OC(=O)C(=C)C)c(F)c2F)c(F)c1F] | RM-31 |
| 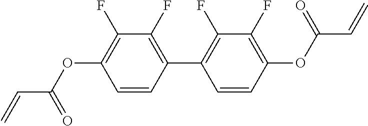 [SMILES: C=CC(=O)Oc1ccc(-c2ccc(OC(=O)C=C)c(F)c2F)c(F)c1F] | RM-32 |
| 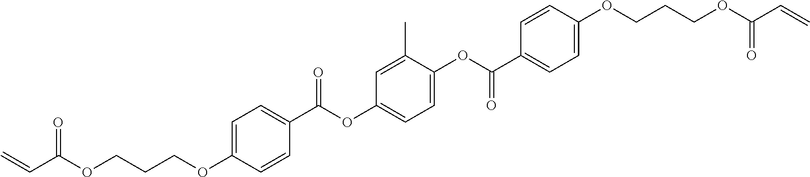 [SMILES: C=CC(=O)OCCCOc1ccc(C(=O)Oc2ccc(OC(=O)c3ccc(OCCCOC(=O)C=C)cc3)c(C)c2)cc1] | RM-33 |
| 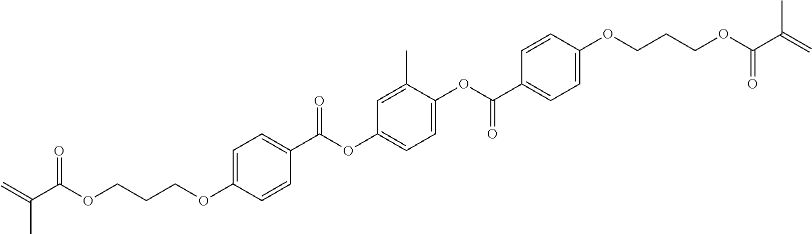 [SMILES: C=C(C)C(=O)OCCCOc1ccc(C(=O)Oc2ccc(OC(=O)c3ccc(OCCCOC(=O)C(=C)C)cc3)c(C)c2)cc1] | RM-34 |
| 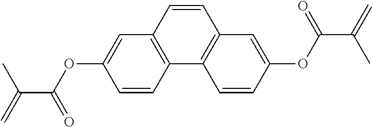 [SMILES: C=C(C)C(=O)Oc1ccc2c(ccc3cc(OC(=O)C(=C)C)ccc32)c1] | RM-35 |
| 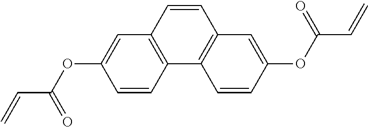 [SMILES: C=CC(=O)Oc1ccc2c(ccc3cc(OC(=O)C=C)ccc32)c1] | RM-36 |
| 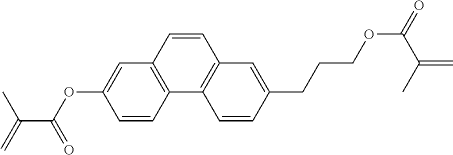 [SMILES: C=C(C)C(=O)OCCCc1ccc2c(ccc3cc(OC(=O)C(=C)C)ccc32)c1] | RM-37 |
| 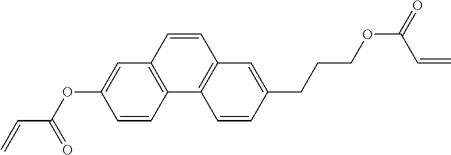 [SMILES: C=CC(=O)OCCCc1ccc2c(ccc3cc(OC(=O)C=C)ccc32)c1] | RM-38 |
| 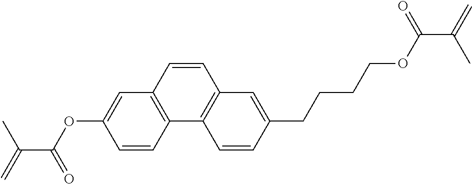 [SMILES: C=C(C)C(=O)OCCCCc1ccc2c(ccc3cc(OC(=O)C(=C)C)ccc32)c1] | RM-39 |
| 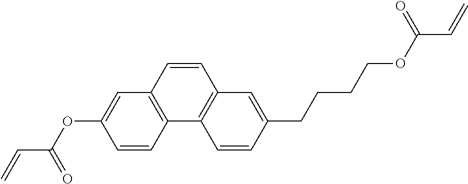 [SMILES: C=CC(=O)OCCCCc1ccc2c(ccc3cc(OC(=O)C=C)ccc32)c1] | RM-40 |
| 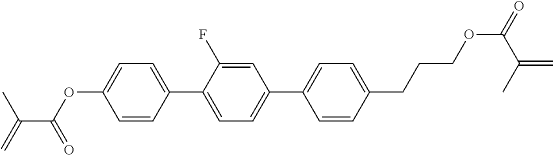 [SMILES: C=C(C)C(=O)OCCCc1ccc(-c2ccc(-c3ccc(OC(=O)C(=C)C)cc3)c(F)c2)cc1] | RM-41 |
| 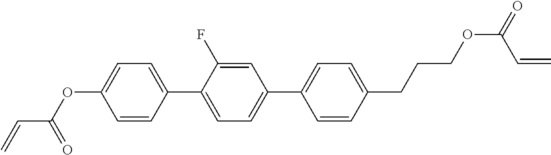 [SMILES: C=CC(=O)OCCCc1ccc(-c2ccc(-c3ccc(OC(=O)C=C)cc3)c(F)c2)cc1] | RM-42 |
| 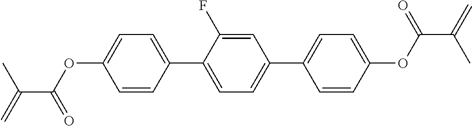 [SMILES: C=C(C)C(=O)Oc1ccc(-c2ccc(-c3ccc(OC(=O)C(=C)C)cc3)c(F)c2)cc1] | RM-43 |
| 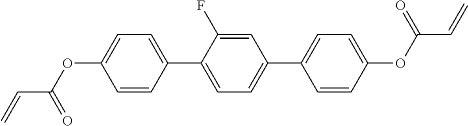 [SMILES: C=CC(=O)Oc1ccc(-c2ccc(-c3ccc(OC(=O)C=C)cc3)c(F)c2)cc1] | RM-44 |
| 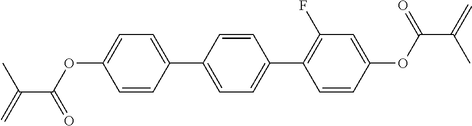 [SMILES: C=C(C)C(=O)Oc1ccc(-c2ccc(-c3ccc(OC(=O)C(=C)C)cc3F)cc2)cc1] | RM-45 |
| 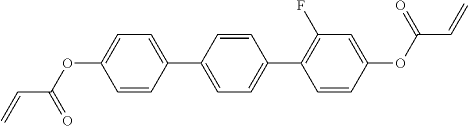 [SMILES: C=CC(=O)Oc1ccc(-c2ccc(-c3ccc(OC(=O)C=C)cc3F)cc2)cc1] | RM-46 |
| 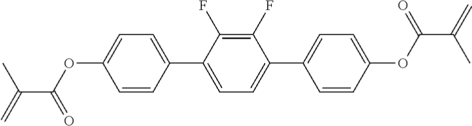 [SMILES: C=C(C)C(=O)Oc1ccc(-c2ccc(-c3ccc(OC(=O)C(=C)C)cc3)c(F)c2F)cc1] | RM-47 |
| 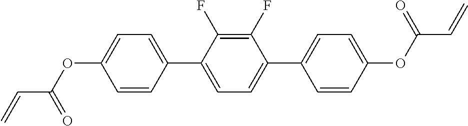 [SMILES: C=CC(=O)Oc1ccc(-c2ccc(-c3ccc(OC(=O)C=C)cc3)c(F)c2F)cc1] | RM-48 |
| 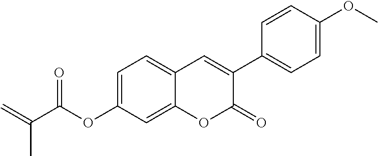 [SMILES: C=C(C)C(=O)Oc1ccc2cc(-c3ccc(OC)cc3)c(=O)oc2c1] | RM-49 |
| 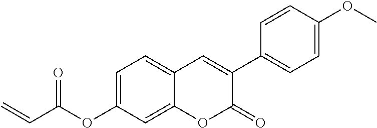 [SMILES: C=CC(=O)Oc1ccc2cc(-c3ccc(OC)cc3)c(=O)oc2c1] | RM-50 |
| 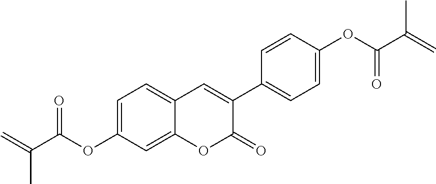 [SMILES: C=C(C)C(=O)Oc1ccc(-c2cc3ccc(OC(=O)C(=C)C)cc3oc2=O)cc1] | RM-51 |
| 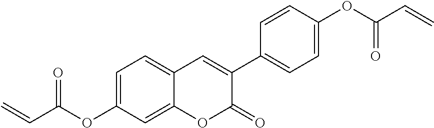 [SMILES: C=CC(=O)Oc1ccc(-c2cc3ccc(OC(=O)C=C)cc3oc2=O)cc1] | RM-52 |
| 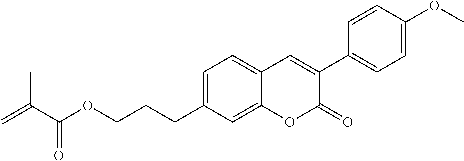 [SMILES: C=C(C)C(=O)OCCCc1ccc2cc(-c3ccc(OC)cc3)c(=O)oc2c1] | RM-53 |
| 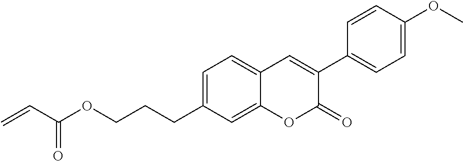 [SMILES: C=CC(=O)OCCCc1ccc2cc(-c3ccc(OC)cc3)c(=O)oc2c1] | RM-54 |
| 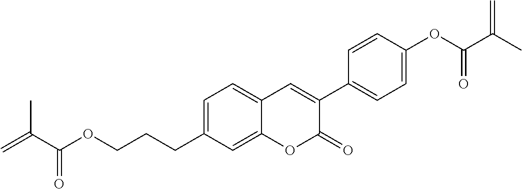 [SMILES: C=C(C)C(=O)OCCCc1ccc2cc(-c3ccc(OC(=O)C(=C)C)cc3)c(=O)oc2c1] | RM-55 |
| 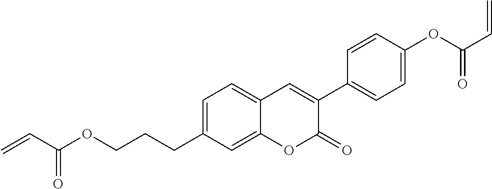 [SMILES: C=CC(=O)OCCCc1ccc2cc(-c3ccc(OC(=O)C=C)cc3)c(=O)oc2c1] | RM-56 |
| 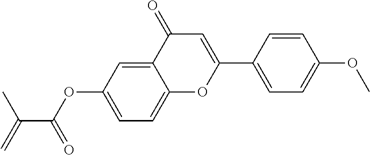 [SMILES: C=C(C)C(=O)Oc1ccc2oc(-c3ccc(OC)cc3)cc(=O)c2c1] | RM-57 |
| 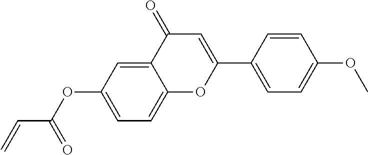 [SMILES: C=CC(=O)Oc1ccc2oc(-c3ccc(OC)cc3)cc(=O)c2c1] | RM-58 |
| 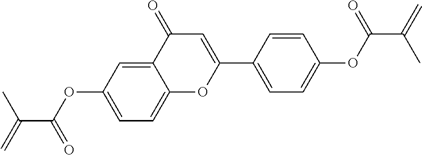 [SMILES: C=C(C)C(=O)Oc1ccc(-c2cc(=O)c3cc(OC(=O)C(=C)C)ccc3o2)cc1] | RM-59 |
| 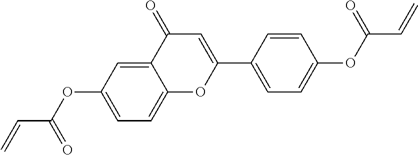 [SMILES: C=CC(=O)Oc1ccc(-c2cc(=O)c3cc(OC(=O)C=C)ccc3o2)cc1] | RM-60 |
| 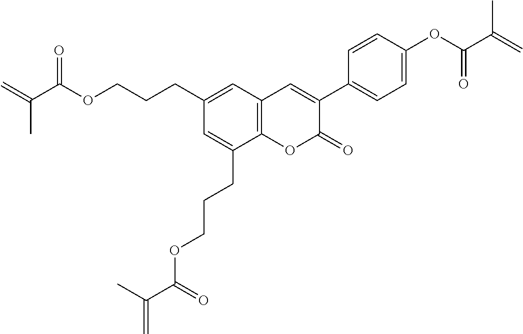 [SMILES: C=C(C)C(=O)OCCCc1cc(CCCOC(=O)C(=C)C)c2oc(=O)c(-c3ccc(OC(=O)C(=C)C)cc3)cc2c1] | RM-61 |
| 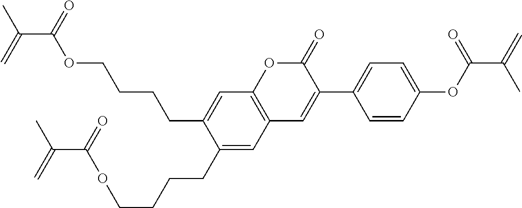 [SMILES: C=C(C)C(=O)OCCCCc1cc2cc(-c3ccc(OC(=O)C(=C)C)cc3)c(=O)oc2cc1CCCCOC(=O)C(=C)C] | RM-62 |
| 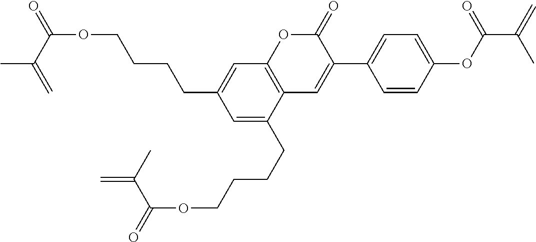 [SMILES: C=C(C)C(=O)OCCCCc1cc(CCCCOC(=O)C(=C)C)c2cc(-c3ccc(OC(=O)C(=C)C)cc3)c(=O)oc2c1] | RM-63 |
| 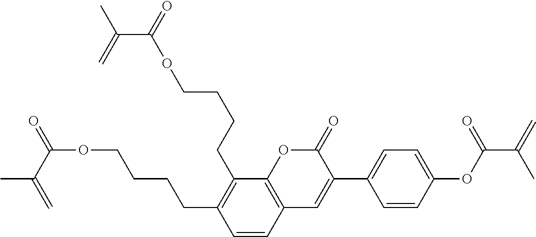 [SMILES: C=C(C)C(=O)OCCCCc1ccc2cc(-c3ccc(OC(=O)C(=C)C)cc3)c(=O)oc2c1CCCCOC(=O)C(=C)C] | RM-64 |
| 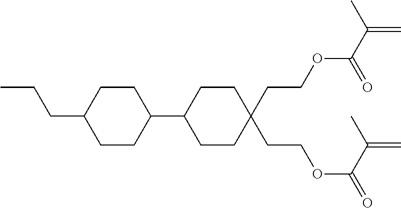 [SMILES: C=C(C)C(=O)OCCC1(CCOC(=O)C(=C)C)CCC(C2CCC(CCC)CC2)CC1] | RM-65 |
| 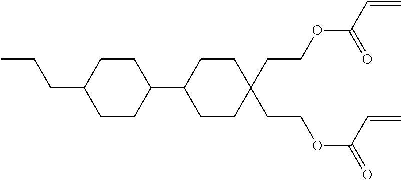 [SMILES: C=CC(=O)OCCC1(CCOC(=O)C=C)CCC(C2CCC(CCC)CC2)CC1] | RM-66 |
| 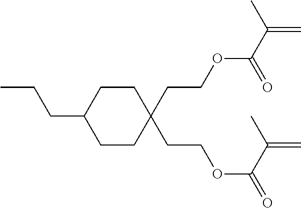 [SMILES: C=C(C)C(=O)OCCC1(CCOC(=O)C(=C)C)CCC(CCC)CC1] | RM-67 |
| 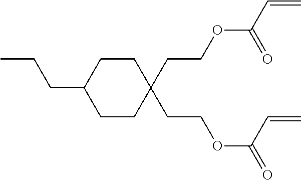 [SMILES: C=CC(=O)OCCC1(CCOC(=O)C=C)CCC(CCC)CC1] | RM-68 |
| 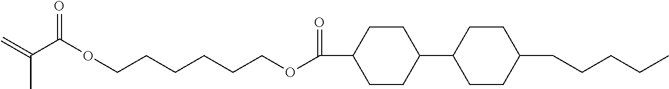 [SMILES: C=C(C)C(=O)OCCCCCCOC(=O)C1CCC(C2CCC(CCCCC)CC2)CC1] | RM-69 |
| 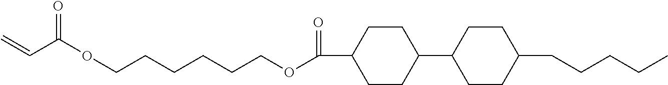 [SMILES: C=CC(=O)OCCCCCCOC(=O)C1CCC(C2CCC(CCCCC)CC2)CC1] | RM-70 |
| 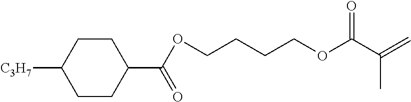 | RM-71 |
| 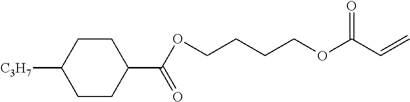 | RM-72 |
| 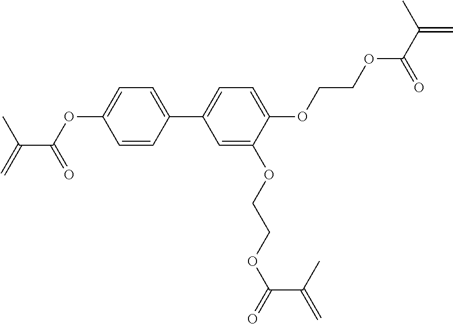 [SMILES: C=C(C)C(=O)OCCOc1ccc(-c2ccc(OC(=O)C(=C)C)cc2)cc1OCCOC(=O)C(=C)C] | RM-73 |
| 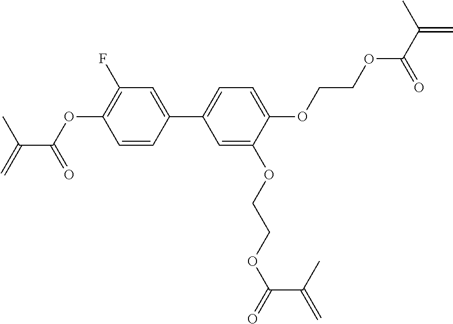 [SMILES: C=C(C)C(=O)OCCOc1ccc(-c2ccc(OC(=O)C(=C)C)c(F)c2)cc1OCCOC(=O)C(=C)C] | RM-74 |
| 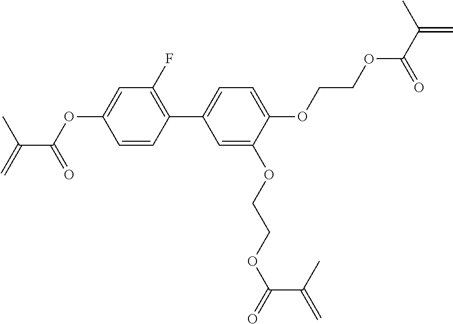 [SMILES: C=C(C)C(=O)OCCOc1ccc(-c2ccc(OC(=O)C(=C)C)cc2F)cc1OCCOC(=O)C(=C)C] | RM-75 |
| 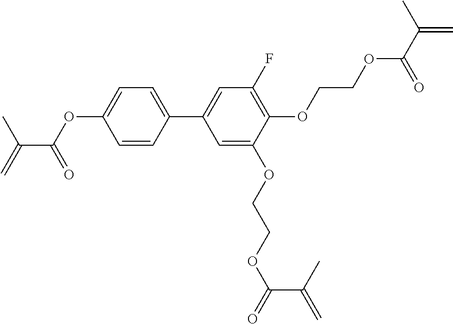 [SMILES: C=C(C)C(=O)OCCOc1cc(-c2ccc(OC(=O)C(=C)C)cc2)cc(F)c1OCCOC(=O)C(=C)C] | RM-76 |
| 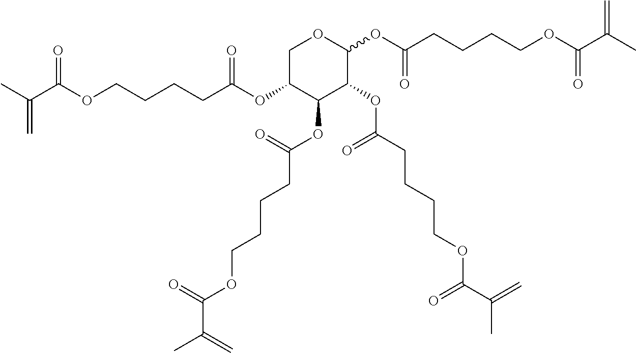 [SMILES: C=C(C)C(=O)OCCCCC(=O)OC1OC[C@@H](OC(=O)CCCCOC(=O)C(=C)C)[C@H](OC(=O)CCCCOC(=O)C(=C)C)[C@H]1OC(=O)CCCCOC(=O)C(=C)C] | RM-77 |
| 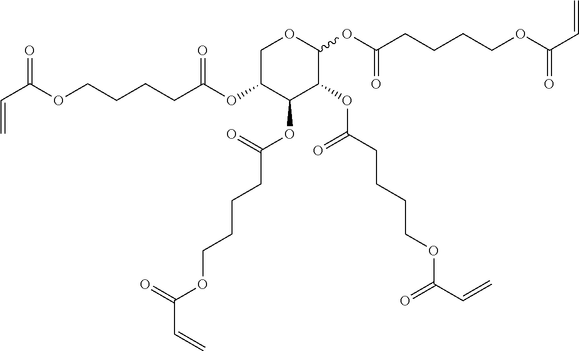 [SMILES: C=CC(=O)OCCCCC(=O)OC1OC[C@@H](OC(=O)CCCCOC(=O)C=C)[C@H](OC(=O)CCCCOC(=O)C=C)[C@H]1OC(=O)CCCCOC(=O)C=C] | RM-78 |
| 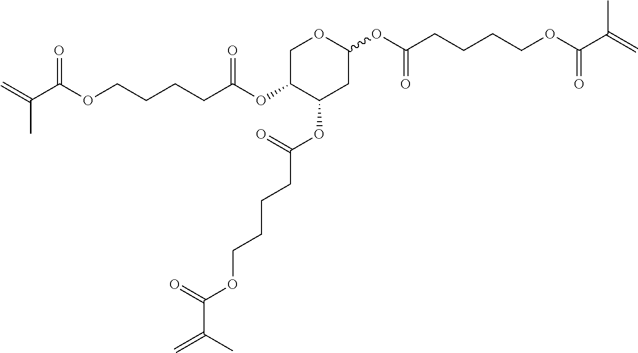 [SMILES: C=C(C)C(=O)OCCCCC(=O)OC1C[C@H](OC(=O)CCCCOC(=O)C(=C)C)[C@H](OC(=O)CCCCOC(=O)C(=C)C)CO1] | RM-79 |
| 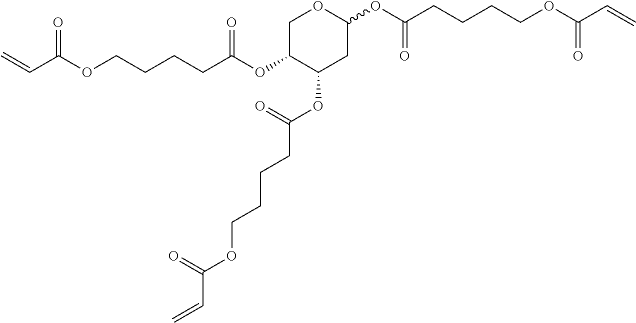 [SMILES: C=CC(=O)OCCCCC(=O)OC1C[C@H](OC(=O)CCCCOC(=O)C=C)[C@H](OC(=O)CCCCOC(=O)C=C)CO1] | RM-80 |
| 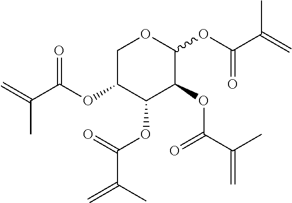 [SMILES: C=C(C)C(=O)OC1OC[C@@H](OC(=O)C(=C)C)[C@@H](OC(=O)C(=C)C)[C@@H]1OC(=O)C(=C)C] | RM-81 |
| 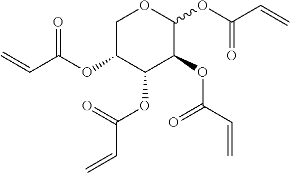 [SMILES: C=CC(=O)OC1OC[C@@H](OC(=O)C=C)[C@@H](OC(=O)C=C)[C@@H]1OC(=O)C=C] | RM-82 |
| 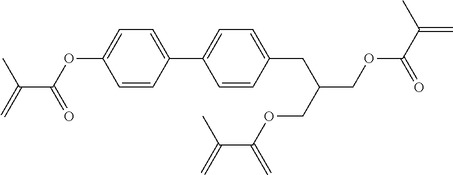 [SMILES: C=C(C)C(=C)OCC(COC(=O)C(=C)C)Cc1ccc(-c2ccc(OC(=O)C(=C)C)cc2)cc1] | RM-83 |
| 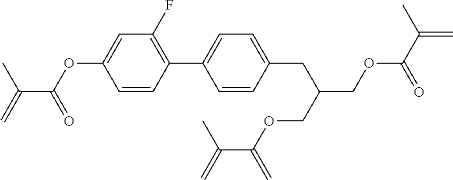 [SMILES: C=C(C)C(=C)OCC(COC(=O)C(=C)C)Cc1ccc(-c2ccc(OC(=O)C(=C)C)cc2F)cc1] | RM-84 |
| 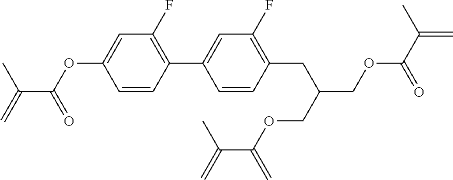 [SMILES: C=C(C)C(=C)OCC(COC(=O)C(=C)C)Cc1ccc(-c2ccc(OC(=O)C(=C)C)cc2F)cc1F] | RM-85 |
| 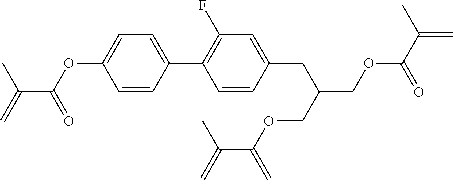 [SMILES: C=C(C)C(=C)OCC(COC(=O)C(=C)C)Cc1ccc(-c2ccc(OC(=O)C(=C)C)cc2)c(F)c1] | RM-86 |
| 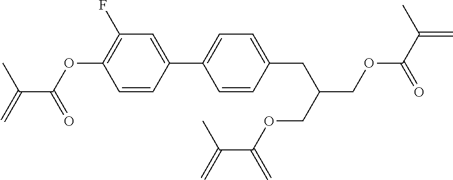 [SMILES: C=C(C)C(=C)OCC(COC(=O)C(=C)C)Cc1ccc(-c2ccc(OC(=O)C(=C)C)c(F)c2)cc1] | RM-87 |
| 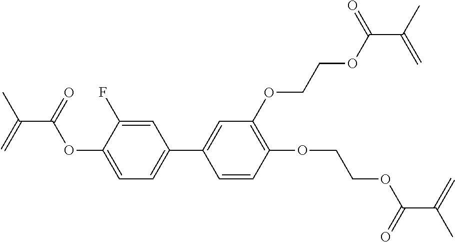 [SMILES: C=C(C)C(=O)OCCOc1ccc(-c2ccc(OC(=O)C(=C)C)c(F)c2)cc1OCCOC(=O)C(=C)C] | RM-88 |
| 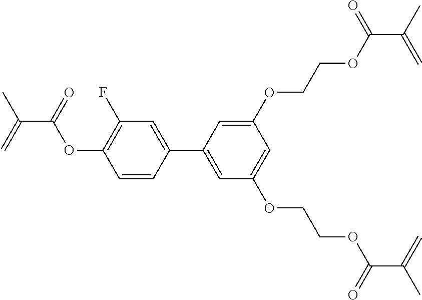 [SMILES: C=C(C)C(=O)OCCOc1cc(OCCOC(=O)C(=C)C)cc(-c2ccc(OC(=O)C(=C)C)c(F)c2)c1] | RM-89 |
| 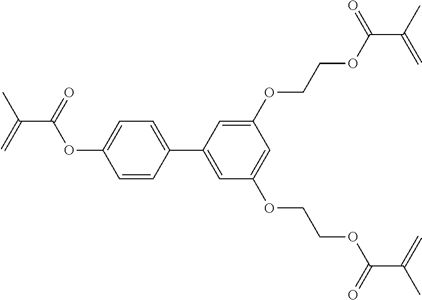 [SMILES: C=C(C)C(=O)OCCOc1cc(OCCOC(=O)C(=C)C)cc(-c2ccc(OC(=O)C(=C)C)cc2)c1] | RM-90 |
| 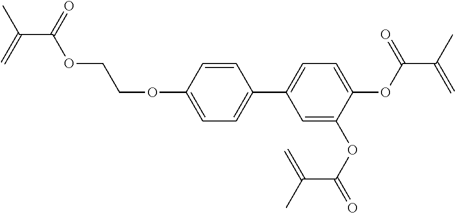 [SMILES: C=C(C)C(=O)OCCOc1ccc(-c2ccc(OC(=O)C(=C)C)c(OC(=O)C(=C)C)c2)cc1] | RM-91 |
| 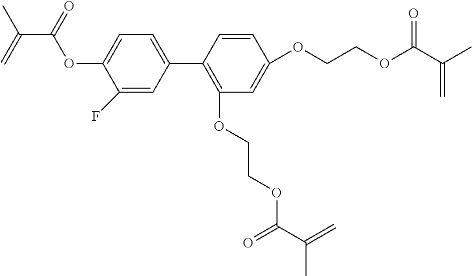 [SMILES: C=C(C)C(=O)OCCOc1ccc(-c2ccc(OC(=O)C(=C)C)c(F)c2)c(OCCOC(=O)C(=C)C)c1] | RM-92 |
| 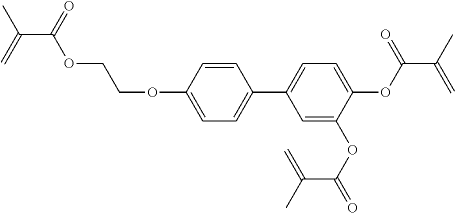 [SMILES: C=C(C)C(=O)OCCOc1ccc(-c2ccc(OC(=O)C(=C)C)c(OC(=O)C(=C)C)c2)cc1] | RM-93 |
| 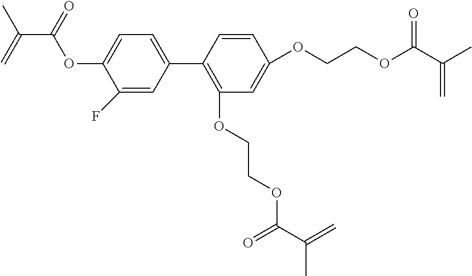 [SMILES: C=C(C)C(=O)OCCOc1ccc(-c2ccc(OC(=O)C(=C)C)c(F)c2)c(OCCOC(=O)C(=C)C)c1] | RM-94 |
| 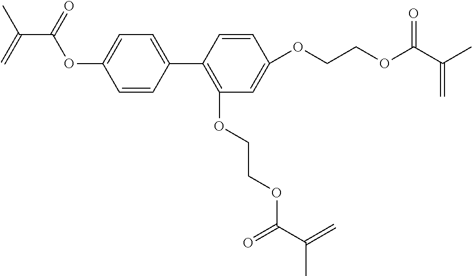 [SMILES: C=C(C)C(=O)OCCOc1ccc(-c2ccc(OC(=O)C(=C)C)cc2)c(OCCOC(=O)C(=C)C)c1] | RM-95 |
| 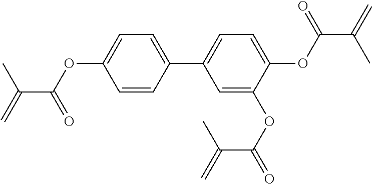 [SMILES: C=C(C)C(=O)Oc1ccc(-c2ccc(OC(=O)C(=C)C)c(OC(=O)C(=C)C)c2)cc1] | RM-96 |
| 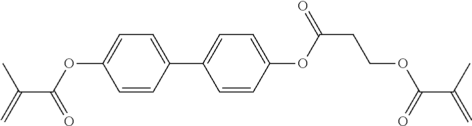 [SMILES: C=C(C)C(=O)OCCC(=O)Oc1ccc(-c2ccc(OC(=O)C(=C)C)cc2)cc1] | RM-97 |
| 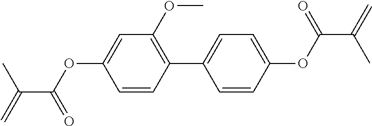 [SMILES: C=C(C)C(=O)Oc1ccc(-c2ccc(OC(=O)C(=C)C)cc2OC)cc1] | RM-98 |
| 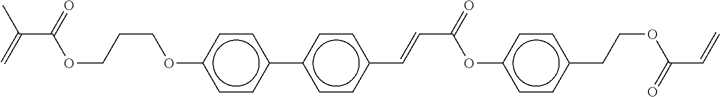 | RM-99 |
| 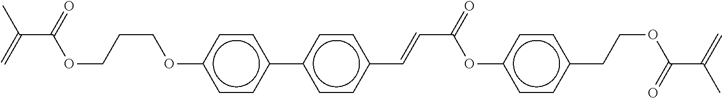 | RM-100 |

In a preferred embodiment of the present invention, the mesogenic media comprise one or more compounds selected from the group of the compounds from Table D.

The following mixture examples are intended to explain the invention without limiting it.

Above and below, percentage data denote percent by weight. All temperatures are indicated in degrees Celsius. m.p. denotes melting point, cl.p.=clearing point. Furthermore, C=crystalline state, N=nematic phase, S=smectic phase and I=isotropic phase. The data between these symbols represent the transition temperatures. Furthermore,
Δn denotes the optical anisotropy at 589 nm and 20° C.,
γ₁ denotes the rotational viscosity (mPa·s) at 20° C.,
Δε denotes the dielectric anisotropy at 20° C. and 1 kHz (Δε=ε_{∥}−ε_{⊥}, where ε_{∥} denotes the dielectric constant parallel to the longitudinal axes of the molecules and ε_{⊥} denotes the dielectric constant perpendicular thereto),
V₁₀ denotes the voltage (V) for 10% transmission (viewing angle perpendicular to the plate surface), (threshold voltage), determined in a TN cell (90 degree twist) at the 1st minimum (i.e. at a dΔn value of 0.5 μm) at 20° C.,
V₀ denotes the capacitively determined Freedericks threshold voltage in an antiparallel-rubbed cell at 20° C.

All physical properties are determined in accordance with “Merck Liquid Crystals, Physical Properties of Liquid Crystals”, status November 1997, Merck KGaA, Germany, and apply for a temperature of 20° C., unless explicitly indicated otherwise.

### EXAMPLES

### Example 1

| | | | |
|---|---|---|---|
| CC-3-V | 33.00% | Clearing point [° C.]: | 75.5 |
| BCH-2F.F | 3.50% | Δn [589 nm, 20° C.]: | 0.1286 |
| BCH-3F.F | 6.00% | Δε [1 kHz, 20° C.]: | +3.8 |
| BCH-5F.F | 6.00% | γ₁ [mPa · s, 20° C.]: | 66 |
| PGP-2-3 | 5.50% | V₁₀ [V]: | 2.04 |
| PGP-2-4 | 5.00% | LTS bulk [h, −20° C.]: | >1000 |
| PGP-2-5 | 11.50% | S → N transition [° C.]: | −22.5 |
| BCH-3F.F.F | 9.00% | | |
| BCH-5F.F.F | 9.00% | | |
| PCH-3-Cl | 6.00% | | |
| CPP-3-F | 5.50% | | |

### Example 2

| | | | |
|---|---|---|---|
| PUQU-3-F | 11.00% | Clearing point [° C.]: | 74.5 |
| CPP-2-F | 4.00% | Δn [589 nm, 20° C.]: | 0.1270 |
| CPP-3-F | 4.00% | Δε [1 kHz, 20° C.]: | +3.8 |
| BCH-3F.F.F | 3.00% | γ₁ [mPa · s, 20° C.]: | 60 |
| CP-3-Cl | 10.50% | V₁₀ [V]: | 2.03 |
| CC-3-V | 27.00% | LTS bulk [h, −20° C.]: | >1000 |
| PGP-2-3 | 11.00% | S → N transition [° C.]: | |
| PGP-2-4 | 11.00% | | |
| CCP-V-1 | 18.50% | | |

### Example 3

| | | | |
|---|---|---|---|
| PUQU-3-F | 8.00% | Clearing point [° C.]: | 78.5 |
| BCH-3F.F.F | 14.00% | Δn [589 nm, 20° C.]: | 0.1320 |
| CPP-2-F | 6.00% | Δε [1 kHz, 20° C.]: | +4.2 |
| PCH-3Cl | 6.00% | γ₁ [mPa · s, 20° C.]: | 67 |
| CC-3-V | 33.00% | V₁₀ [V]: | 2.00 |
| CPGP-5-2 | 3.00% | LTS bulk [h, −20° C.]: | >1000 |
| CPGP-5-3 | 3.00% | S → N transition [° C.]: | |
| PGP-2-3 | 10.00% | | |
| PGP-2-4 | 11.00% | | |
| CCP-V-1 | 6.00% | | |

### Example 4

| | | | |
|---|---|---|---|
| PUQU-3-F | 8.00% | Clearing point [° C.]: | 75.5 |
| BCH-3F.F.F | 11.00% | Δn [589 nm, 20° C.]: | 0.1157 |
| CP-3-Cl | 15.00% | Δε [1 kHz, 20° C.]: | +3.9 |
| CC-3-V | 32.00% | γ₁ [mPa · s, 20° C.]: | 63 |
| CPGP-5-2 | 5.00% | V₁₀ [V]: | 2.00 |
| CPGP-5-3 | 4.00% | LTS bulk [h, −20° C.]: | >1000 |
| PGP-2-3 | 5.00% | S → N transition [° C.]: | |
| PGP-2-4 | 5.00% | | |
| CCP-V-1 | 15.00% | | |

### Example 5

| | | | |
|---|---|---|---|
| CC-3-V | 32.00% | Clearing point [° C.]: | 74 |
| CC-3-V1 | 5.00% | Δn [589 nm, 20° C.]: | 0.1156 |
| PCH-3Cl | 3.00% | Δε [1 kHz, 20° C.]: | +4.3 |
| PUQU-3-F | 18.00% | γ₁ [mPa · s, 20° C.]: | 55 |
| BCH-5F | 8.00% | V₁₀ [V]: | 1.97 |
| PGP-2-3 | 8.00% | LTS bulk [h, −20° C.]: | 912 |
| PGP-2-5 | 8.00% | S → N transition [° C.]: | −20 |
| CCP-V-1 | 18.00% | | |

### Example 6

| | | | |
|---|---|---|---|
| PGU-2-F | 5.00% | Clearing point [° C.]: | 75.5 |
| PGU-3-F | 7.00% | Δn [589 nm, 20° C.]: | 0.1258 |
| PUQU-3-F | 10.00% | Δε [1 kHz, 20° C.]: | +4.8 |
| CP-3-Cl | 5.00% | γ₁ [mPa · s, 20° C.]: | 59 |
| CCP-V-1 | 13.50% | V₁₀ [V]: | 1.90 |
| CCP-V2-1 | 7.00% | LTS bulk [h, −20° C.]: | >1000 |
| CC-3-V1 | 8.00% | S → N transition [° C.]: | |
| CC-3-V | 27.50% | | |
| PGP-2-3 | 6.00% | | |
| PGP-2-4 | 6.00% | | |
| PGP-3-3 | 5.00% | | |

| | | | |
|---|---|---|---|
| CPGU-2-OT | 2.50% | Clearing point [° C.]: | 77 |
| CPGU-3-OT | 3.00% | Δn [589 nm, 20° C.]: | 0.1266 |
| PGU-2-F | 5.00% | Δε [1 kHz, 20° C.]: | +4.7 |
| PGU-3-F | 5.00% | γ₁ [mPa · s, 20° C.]: | 58 |
| PUQU-2-F | 4.00% | V₁₀ [V]: | 1.90 |
| PUQU-3-F | 3.00% | LTS bulk [h, −20° C.]: | >1000 |
| CCP-V-1 | 13.00% | S → N transition [° C.]: | |
| CC-3-V1 | 7.00% | | |
| PGP-2-3 | 6.00% | | |
| PGP-2-4 | 6.50% | | |
| PGP-2-5 | 7.00% | | |
| CC-3-V | 35.00% | | |
| PCH-3Cl | 3.00% | | |

### Example 7

| | | | |
|---|---|---|---|
| CC-3-V | 20.00% | Clearing point [° C.]: | 75 |
| CC-3-V1 | 12.50% | Δn [589 nm, 20° C.]: | 0.1230 |
| PP-1-2V1 | 8.00% | Δε [1 kHz, 20° C.]: | +5.0 |
| PCH-3Cl | 3.00% | γ₁ [mPa · s, 20° C.]: | 65 |
| PUQU-3-F | 14.00% | V₁₀ [V]: | 1.96 |
| CGU-3-F | 6.50% | LTS bulk [h, −20° C.]: | >1000 |
| BCH-3F.F | 3.00% | S → N transition [° C.]: | −20 |
| PGP-2-3 | 6.50% | | |
| PGP-2-4 | 6.00% | | |
| CCP-V-1 | 16.00% | | |
| CBC-33 | 2.00% | | |
| CCGU-3-F | 2.50% | | |

### Example 8

### Example 9

| | | | |
|---|---|---|---|
| CC-3-V | 42.00% | Clearing point [° C.]: | 75 |
| PCH-3Cl | 5.00% | Δn [589 nm, 20° C.]: | 0.1362 |
| PP-1-2V1 | 7.00% | Δε [1 kHz, 20° C.]: | +5.5 |
| PGP-2-3 | 7.00% | γ₁ [mPa · s, 20° C.]: | 61 |
| PGP-2-4 | 8.00% | V₁₀ [V]: | 1.81 |
| PGP-2-5 | 10.00% | LTS bulk [h, −20° C.]: | >1000 |
| CPGU-3-OT | 5.00% | S → N transition [° C.]: | −20 |
| APUQU-3-F | 9.00% | | |
| PGUQU-3-F | 7.00% | | |

### Example 10

| | | | |
|---|---|---|---|
| CCGU-5-F | 5.00% | Clearing point [° C.]: | 80 |
| PUQU-2-F | 6.00% | Δn [589 nm, 20° C.]: | 0.1147 |
| PUQU-3-F | 11.00% | Δε [1 kHz, 20° C.]: | +5.6 |
| CC-3-V1 | 9.00% | γ₁ [mPa · s, 20° C.]: | 67 |
| CCP-V-1 | 20.00% | V₁₀ [V]: | 1.83 |
| CCGU-3-F | 6.00% | LTS bulk [h, −20° C.]: | >1000 |
| PP-1-2V1 | 2.00% | S → N transition [° C.]: | |
| CC-3-V | 26.00% | | |
| PGP-2-3 | 7.00% | | |
| PGP-2-4 | 8.00% | | |
| GP-2-Cl | 2.00% | | |

### Example 11

| | | | |
|---|---|---|---|
| CPGU-3-OT | 10.00% | Clearing point [° C.]: | 77.5 |
| CC-3V | 32.50% | Δn [589 nm, 20° C.]: | 0.1240 |
| CC-3-V1 | 6.00% | Δε [1 kHz, 20° C.]: | +4.6 |
| CCP-V-1 | 16.50% | γ₁ [mPa · s, 20° C.]: | 62 |
| PGP-2-4 | 6.50% | V₁₀ [V]: | 2.04 |
| PGP-2-5 | 7.00% | LTS bulk [h, −20° C.]: | >1000 |
| PP-1-2V1 | 8.00% | S → N transition [° C.]: | |
| PUQU-3-F | 11.50% | | |
| GP-2-Cl | 2.00% | | |

### Example 12

| | | | |
|---|---|---|---|
| PGU-2-F | 5.00% | Clearing point [° C.]: | 74.5 |
| PGU-3-F | 6.50% | Δn [589 nm, 20° C.]: | 0.1259 |
| PUQU-3-F | 10.00% | Δε [1 kHz, 20° C.]: | +4.8 |
| CCP-V-1 | 13.50% | γ₁ [mPa · s, 20° C.]: | 59 |
| CCP-V2-1 | 6.00% | V₁₀ [V]: | 1.92 |
| CC-3-V1 | 8.00% | LTS bulk [h, −20° C.]: | >1000 |
| CC-3-V | 38.00% | S → N transition [° C.]: | |
| PGP-2-3 | 4.00% | | |
| PGP-2-4 | 4.00% | | |
| PGP-2-5 | 10.00% | | |
| GP-2-Cl | 3.00% | | |

### Example 13

| | | | |
|---|---|---|---|
| CPGU-2-F | 3.00% | Clearing point [° C.]: | 74.5 |
| CPGU-3-F | 3.00% | Δn [589 nm, 20° C.]: | 0.1258 |
| PGU-2-F | 5.00% | Δε [1 kHz, 20° C.]: | +4.7 |
| PGU-3-F | 5.00% | γ₁ [mPa · s, 20° C.]: | 57 |
| PUQU-2-F | 4.00% | V₁₀ [V]: | 1.92 |
| PUQU-3-F | 3.00% | LTS bulk [h, −20° C.]: | >1000 |
| CCP-V-1 | 14.00% | S → N transition [° C.]: | |
| CC-3-V1 | 6.00% | | |
| PGP-2-3 | 5.00% | | |
| PGP-2-4 | 5.00% | | |
| PGP-2-5 | 6.00% | | |
| CC-3-V | 35.00% | | |
| PCH-3Cl | 3.00% | | |
| PP-1-2V1 | 3.00% | | |

### Example 14

| | | | |
|---|---|---|---|
| CC-3-V | 45.50% | Clearing point [° C.]: | 73 |
| PP-1-2V1 | 4.00% | Δn [589 nm, 20° C.]: | 0.1339 |
| PGP-2-3 | 7.00% | Δε [1 kHz, 20° C.]: | +7.6 |
| PGP-2-4 | 6.50% | γ₁ [mPa · s, 20° C.]: | 62 |
| PGP-2-5 | 5.00% | V₁₀ [V]: | 1.56 |
| PGUQU-3-F | 13.00% | LTS bulk [h, −20° C.]: | >1000 |
| CPGU-3-OT | 5.00% | S → N transition [° C.]: | |
| PGU-3-F | 4.00% | | |
| APUQU-3-F | 7.00% | | |
| GP-2-Cl | 3.00% | | |

### Example 15

| | | | |
|---|---|---|---|
| CC-3-V | 33.00% | Clearing point [° C.]: | 75.5 |
| BCH-2F.F | 3.00% | Δn [589 nm, 20° C.]: | 0.1298 |
| BCH-3F.F | 7.00% | Δε [1 kHz, 20° C.]: | +4.0 |
| BCH-5F.F | 8.00% | γ₁ [mPa · s, 20° C.]: | 69 |
| PGP-2-3 | 4.00% | V₁₀ [V]: | 2.01 |
| PGP-2-4 | 4.00% | LTS bulk [h, −20° C.]: | >1000 |
| PGP-2-5 | 13.00% | S → N transition [° C.]: | −21 |
| BCH-3F.F.F | 10.00% | | |
| BCH-5F.F.F | 10.00% | | |
| PP-5-F | 4.00% | | |
| CPP-3-F | 4.00% | | |

### Example 16

| | | | |
|---|---|---|---|
| CC-3-V | 32.50% | Clearing point [° C.]: | 75 |
| BCH-3F.F | 7.00% | Δn [589 nm, 20° C.]: | 0.1305 |
| BCH-5F.F | 7.00% | Δε [1 kHz, 20° C.]: | +4.2 |
| PGP-2-3 | 4.50% | γ₁ [mPa · s, 20° C.]: | 69 |
| PGP-2-4 | 4.50% | V₁₀ [V]: | 1.97 |
| PGP-2-5 | 13.00% | LTS bulk [h, −20° C.]: | >1000 |
| BCH-3F.F.F | 9.00% | S → N transition [° C.]: | |
| BCH-5F.F.F | 10.00% | | |
| PP-5-F | 4.00% | | |
| CPP-3-F | 4.50% | | |
| CGU-3-F | 4.00% | | |

### Example 17

| | | | |
|---|---|---|---|
| CC-3-V | 36.00% | Clearing point [° C.]: | 74 |
| PGP-2-3 | 6.00% | Δn [589 nm, 20° C.]: | 0.1295 |
| PGP-2-4 | 6.00% | Δε [1 kHz, 20° C.]: | +3.9 |
| PGP-2-5 | 13.00% | γ₁ [mPa · s, 20° C.]: | 58 |
| CGU-3-F | 5.50% | V₁₀ [V]: | 2.00 |
| CCPU-3-F | 3.00% | LTS bulk [h, −20° C.]: | >1000 |
| BCH-3F.F.F | 10.50% | S → N transition [° C.]: | |
| BCH-5F.F.F | 10.50% | | |
| CPP-3-F | 5.00% | | |
| PP-5-F | 4.50% | | |

1. Liquid-crystalline medium, characterised in that it comprises one or more compounds of the formula 1, 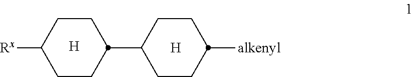
and one or more compounds of the formula 2, 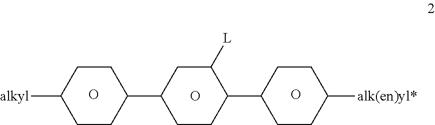
and one or more compounds selected from formulae 3, 4 and 5, 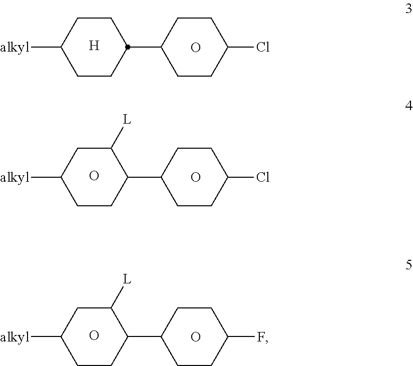
in which the individual radicals, in each case independently of one another and identically or differently on each occurrence, have the following meanings:
alkenyl denotes C₂₋₆-alkenyl,
R^{x} denotes C₁₋₆-alkyl or C₂₋₆-alkenyl,
alkyl and alkyl* each, independently of one another, denote C₁₋₆-alkyl,
L denotes H or F,
alk(en)yl* denotes C₁₋₆-alkyl or C₂₋₆-alkenyl.

2. Liquid-crystalline medium according to claim 1, characterised in that it comprises one or more compounds of the formula 1 selected from the following formulae: 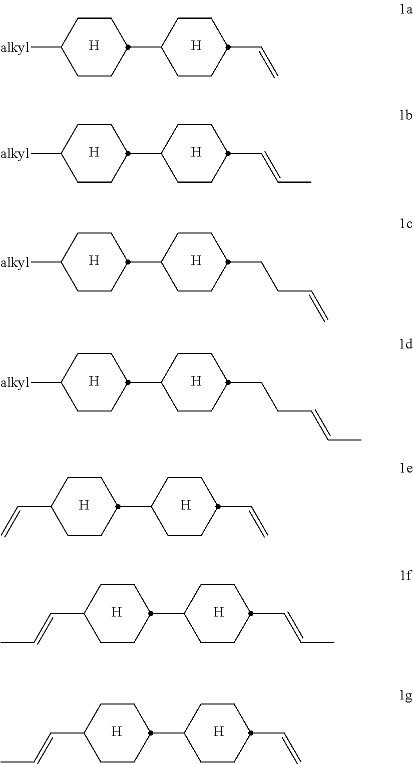
in which “alkyl” has the meaning indicated in claim 1.

3. Liquid-crystalline medium according to claim 1, characterised in that it comprises one or more compounds of the formula 2 selected from the following formulae:

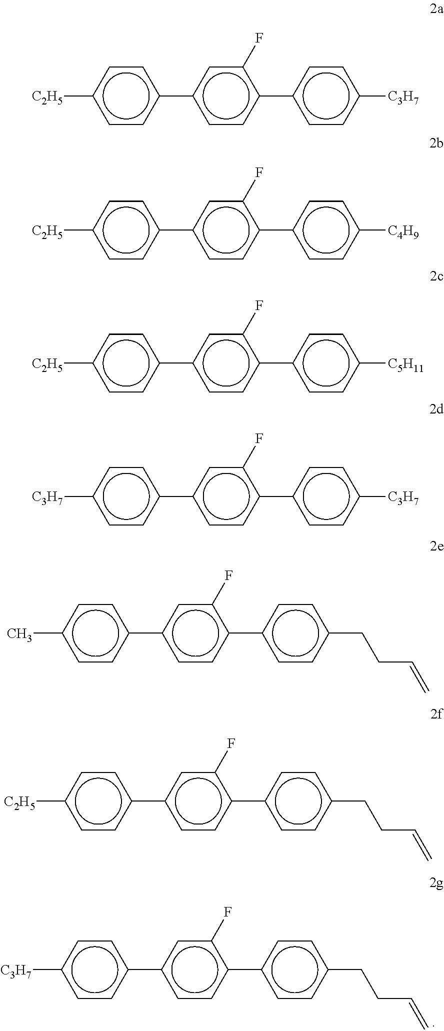

4. Liquid-crystalline medium according to claim 1, characterised in that it comprises one or more compounds of the formula 3 selected from the following formulae:

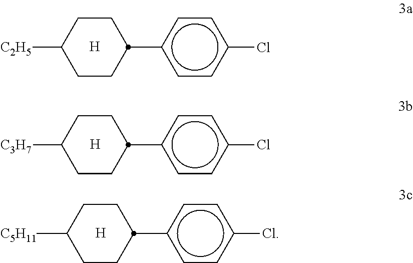

5. Liquid-crystalline medium according to claim 1, characterised in that it comprises one or more compounds of the formula 4 selected from the following formulae:

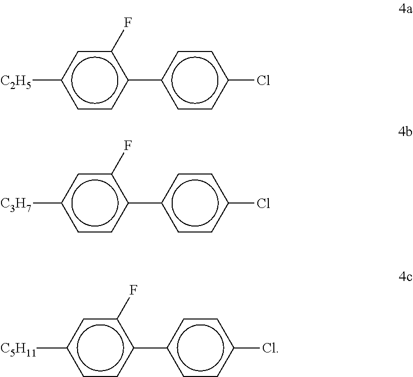

6. Liquid-crystalline medium according to claim 1, characterised in that it comprises one or more compounds of the formula 5 selected from the following formulae:

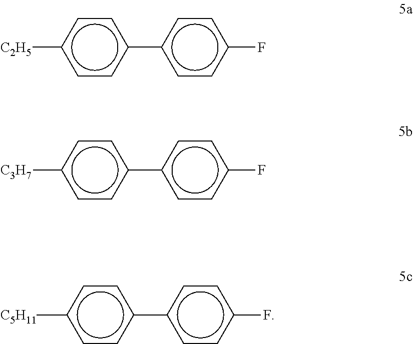

7. Liquid-crystalline medium according to claim 2, comprising
one or more compounds selected from the formulae 1a and 1b, and
two or more compounds selected from the formula 2a to 2d, and a compound of the formula 3b or 4b or 5c

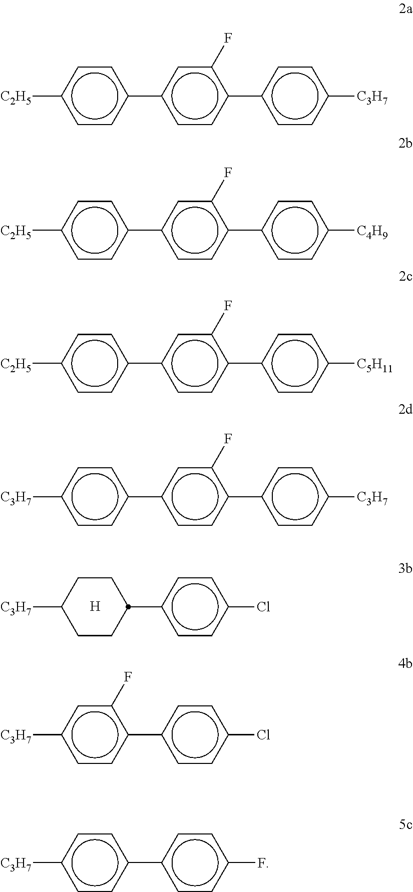

8. Liquid-crystalline medium according to claim 1, comprising
20 to 65% by weight of one or more compounds of the formula 1, and
5 to 30% by weight of one or more compounds of the formula 2, and
2 to 20% by weight of one or more compounds selected from the formulae 3, 4 and 5.

9. Liquid-crystalline medium according to claim 1, characterised in that it additionally comprises one or more compounds selected from formulae II and/or III, 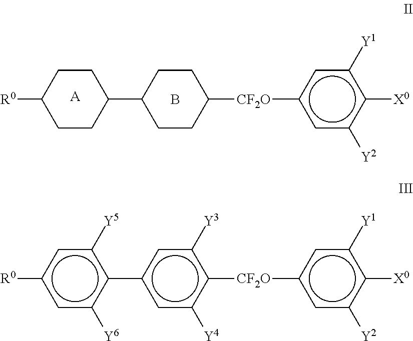
in which
R⁰ denotes unsubstituted or halogenated alkyl or alkoxy having 1 to 15 C atoms, cyclopentyl or cyclobutyl, where, in addition, one or more CH₂ groups in these radicals may each be replaced, independently of one another, by —C≡C—, —CF₂O—, —CH═CH—, 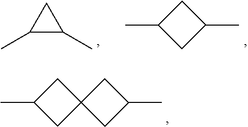
—O—, —CO—O— or —O—CO— in such a way that O atoms are not linked directly to one another,
X⁰ denotes F, Cl, halogenated alkyl, halogenated alkoxy, halogenated alkenyl or halogenated alkenyloxy, each having up to 6 C atoms,
Y¹⁻⁶ each, independently of one another, denote H or F, and 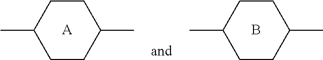
and each, independently of one another, denote

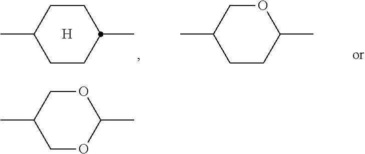

10. Liquid-crystalline medium according to claim 9, characterised in that it additionally comprises one or more compounds selected from the formulae IV to VIII, 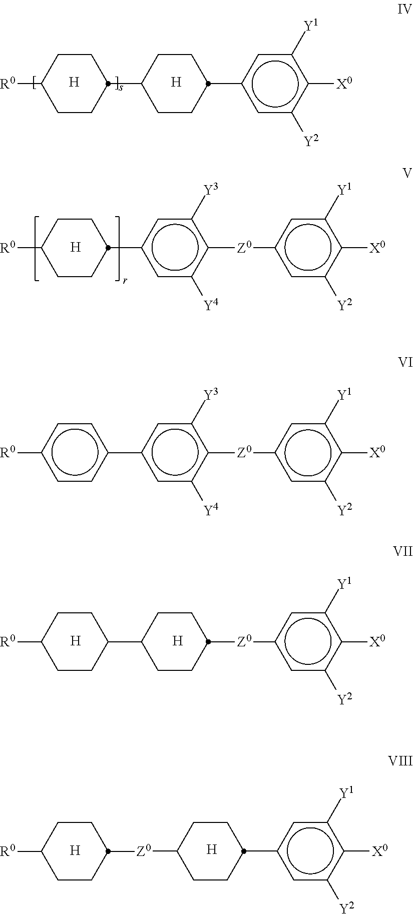
in which R⁰, X⁰ and Y¹⁻⁴ have the meanings indicated in claim 9,
Z⁰ denotes —C₂H₄—, —(CH₂)₄—, —CH═CH—, —CF═CF—, —C₂F₄—, —CH₂CF₂—, —CF₂CH₂—, —CH₂O—, —OCH₂—, —COO— or —OCF₂—, in formulae V and VI also a single bond, in formulae V and VIII also —CF₂O—,
r denotes 0 or 1, and
s denotes 0 or 1.

11. Liquid-crystalline medium according to claim 9, characterised in that it additionally comprises one or more compounds selected from the formulae IX to XII, 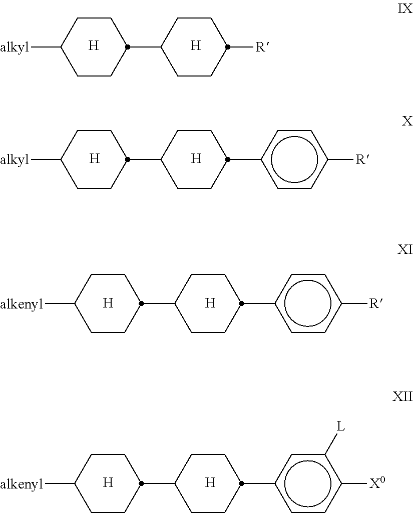
in which X⁰ has the meaning indicated in claim 9, and
L denotes H or F,
“alkyl” denotes C₁₋₆-alkyl,
R′ denotes C₁₋₆-alkyl, C₁₋₆-alkoxy or C₂₋₆-alkenyl, and
“alkenyl” and “alkenyl*” each, independently of one another, denote C₂₋₆-alkenyl.

12. Liquid-crystalline medium according to claim 1, characterised in that it additionally comprises one or more compounds of the formula XIII, 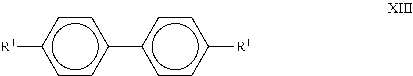
in which R¹ and R² each, independently of one another, denote n-alkyl, alkoxy, oxaalkyl, fluoroalkyl or alkenyl, each having up to 6 C atoms.

13. Liquid-crystalline medium according to claim 9, characterised in that it additionally comprises one or more compounds selected from the formulae XV and XVI, 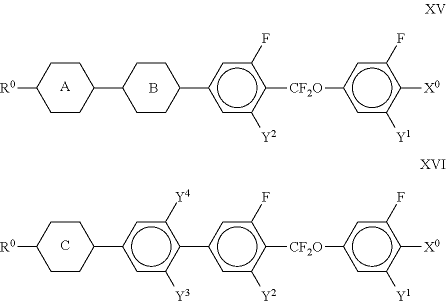
in which R⁰, X⁰ and Y¹⁻⁴ have the meanings indicated in claim 9, 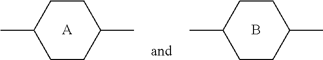
each, independently of one another, denote 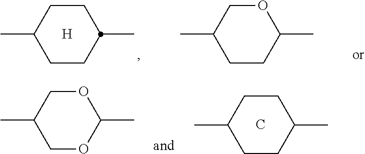
denotes

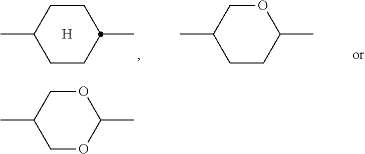

14. Liquid-crystalline medium according to claim 1, characterised in that it additionally comprises one or more compounds selected from the compounds of the following formulae: 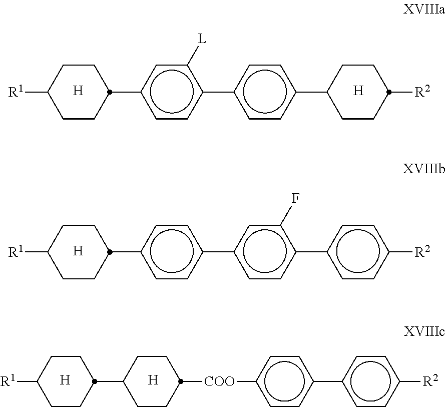
in which R¹ and R² each, independently of one another, denote n-alkyl, alkoxy, oxaalkyl, fluoroalkyl or alkenyl, each having up to 6 C atoms, and L denotes H or F.

15. Liquid-crystalline medium according to claim 9, characterised in that it additionally comprises one or more compounds selected from the group of the compounds of the formulae XIX, XX, XXI, XXII, XXIII and XIV, 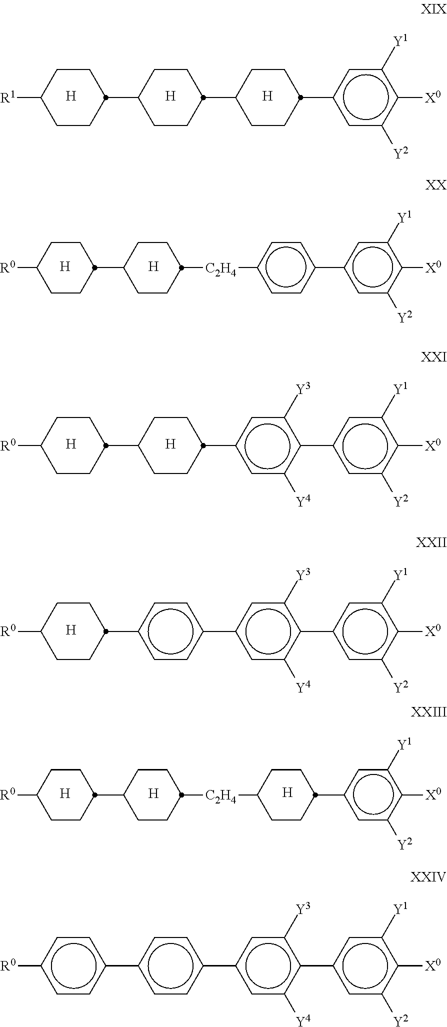
in which R⁰, X⁰ and Y¹⁻⁴ have the meanings indicated in claim 9.

16. Liquid-crystalline medium according to claim 9, characterised in that it additionally comprises one or more compounds of the formula XXX, 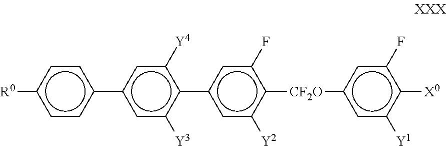
in which R⁰, X⁰ and Y¹⁻⁴ have the meanings indicated in claim 9.

17. Liquid-crystalline medium according to claim 1, characterised in that it additionally comprises one or more additive(s) selected from the group of the UV stabilisers, dopants and antioxidants.

18. Liquid-crystalline medium according to claim 1, characterised in that it additionally comprises one or more polymerisable compounds.

19. Process for the preparation of a liquid-crystalline medium according to claim 1, characterised in that one or more compounds of the formulae 1-5 as defined in claim 1 are mixed with further mesogenic compounds and optionally also with one or more additives and/or at least one polymerisable compound.

20. An electro-optical article comprising a liquid-crystalline medium according to claim 1.

21. An article in shutter spectacles, for 3D applications, in TN, PS-TN, STN, ECB, OCB, IPS, PS-IPS, FFS, HB-FFS, PS-FFS and PS-VA-IPS displays, which comprises a liquid-crystalline medium to claim 1.

22. Electro-optical liquid-crystal display containing a liquid-crystalline medium according to claim 1.

23. Electro-optical liquid-crystal display according to claim 22, characterised in that it is a TN, PS-TN, STN, ECB, OCB, IPS, PS-IPS, FFS, HB-FFS, PS-FFS or positive VA display.
